(19) United States
(12) Patent Application Publication
(10) Pub. No.: US 2025/0270459 A1
(43) Pub. Date: Aug. 28, 2025

(54) SYSTEMS AND METHODS FOR REDOX THERMAL DEGRADATION OF PLASTIC MATERIALS

(71) Applicant: OHIO STATE INNOVATION FOUNDATION, Columbus, OH (US)

(72) Inventors: Liang-Shih Fan, Columbus, OH (US); Andrew Tong, Columbus, OH (US); Eric Falascino, Columbus, OH (US); Rushikesh Joshi, Columbus, OH (US)

(21) Appl. No.: 18/856,529

(22) PCT Filed: Apr. 14, 2023
(86) PCT No.: PCT/US2023/018639

§ 371 Date: Oct. 11, 2024

Related U.S. Application Data
(60) Provisional application No. 63/331,090, filed on Apr. 14, 2022.

(51) Int. Cl. C10J 3/72; B01J 8/08; B01J 8/18; B01J 8/24; C01B 3/06; C10B 53/07; C10J 3/56

(52) U.S. Cl. CPC C10J 3/725; B01J 8/085; B01J 8/1827; B01J 8/1881; B01J 8/24; C01B 3/063; C10B 53/07; C10J 3/56; C10J 3/721; B01J 2208/00769; C10G 2300/1003

(57) ABSTRACT

Exemplary systems and methods relate to processing plastic material. A feedstock comprising plastic material and oxygen carriers comprising active material may be provided to a first reactor. A weight ratio of active material to feedstock may be no less than 4:1 and no greater than 10:1. Oxidation products may be obtained from the first reactor. Reduced oxygen carriers may be provided from the first reactor to a second reactor. Oxidizing material may be provided to the second reactor, which may oxidize the reduced oxygen carriers. Energy and/or a product stream may be obtained from the second reactor.

### CROSS-REFERENCE TO RELATED APPLICATION(S)

This application claims priority to U.S. Provisional Patent Application No. 63/331,090, filed on Apr. 14, 2022, the entire contents of which are hereby incorporated by reference in its entirety.

### FIELD

The present disclosure is related to reactor configurations, operating strategies, and systems for processing plastic materials. More particularly, exemplary systems, reactor configurations, and operating conditions may use moving bed reactor systems to convert plastics into low tar high purity products.

### INTRODUCTION

Plastics play an essential part in everyday life. With the further research being undertaken to enhance their properties, plastics are being used in increasing number of applications. Consequently, the annual plastic production was 368 million tonnes in 2019, with a compounded annual growth rate of 3.5%. The most prominently used plastics are Polyethylene (PE), Polyethylene terephthalate (PET), Polypropylene, Polyvinyl chloride (PVC), Polystyrene (PS), etc. Currently all of these are produced from sources that are directly or indirectly derived from fossil fuels. With an increasing demand and production of these plastics, the strain on the limited fossil resources is increasing, necessitating the need for an efficient, economic, and environmentally attractive recycling process.

Plastics can be subdivided into two general groups: thermosetting and thermoplastics. Both may contain various concentrations of carbon, hydrogen, oxygen, nitrogen, chlorine, fluorine, and sulfur as main constituents, with various other elements in trace amounts to alter physical characteristics depending on the application. Thermosetting plastics (generally known as epoxies) are those which cannot be re-melted after being subjected to heat and pressure once. These types of plastics make up approximately 20% of the produced plastics worldwide.

The most widely used plastics are those that are classified as thermoplastics. These plastics are able to be reprocessed and used as feedstock to supplement the production of virgin material. However, the ability to reprocess them is only as available and economically feasible as the recycling process in the specific geographic region, again, owing to the economies of scale, or lack thereof.

Conventional processing of plastic materials are classified in levels (Primary, Secondary, Tertiary, Quaternary) for recycling, and are based on thermoplastics where complete, circular recycling is possible. Primary recycling is a form of mechanical recycling, requiring complete sorting and segregation of plastics by type, such that they can be remelted and maintain mechanical properties. The biggest challenge to this method is the high cost (both in energy and labor) to ensure complete segregation of the plastic. This method can become cost prohibitive, as the sources of waste often contain a wide mixture of plastics.

Secondary recycling takes a higher grade plastic, and recycles into a lower grade plastic (or feed for a lower grade plastic) due to the contamination of other polymers which reduce the mechanical properties of the plastic. This has its advantages in that the segregation costs are lower since there can be a small percentage of a different plastic species. However, the process of mechanical recycling is still energy intensive, and thus creating an inferior product generally results in the economics being unfavorable unless the scale is large.

Tertiary recycling is a form of chemical recycling, such as gasification, where the depolymerization of the plastics occurs and the feedstock is reduced to a different chemical species altogether. This type of recycling allows for a wide variety of plastics to be handled, with lower segregation required (no chlorinated or fluorinated plastics) and still be able to produce a value-added product, typically syngas. However, the energy requirements of plastics gasification are large due to the operating temperatures and the endothermic reactions associated with the gasification. While syngas is a useful intermediate, it still has a large cost when using gasification as a recycling process.

Quaternary recycling may be described as energy recovery from the plastic waste. In this form of recycling (i.e. pyrolysis, incineration), the use of the waste plastic is as a hydrocarbon fuel. While this allows for energy recovery in the form of heat, the amount of emissions must be controlled; an ever-increasing goal to reduce the effects on climate change.

Both tertiary and quaternary recycling are thermal degradation methods, which have the advantage of accepting a wide variety of waste feeds. This is especially important to the economics of the overall recycling process as there has not yet been a robust method to sort plastics that can compete with the economics of thermal degradation. Furthermore, the energy and emissions as a result of producing plastics are minimally affected by the current level of primary and secondary recycling, largely due to the poor economics of those recycling methods. The ability of thermal degradation methods to accept a wide variety of plastics and still produce their desired result allows them to be much more industrially robust both from the processing side and the process economics.

Traditional thermal degradation methods can be classified into three general types: Gasification, Pyrolysis, and Incineration. Gasification of waste plastics produces a product stream comprised of mainly H₂, CO, CO₂, CH₄, and N₂. The gasifying agent (either steam or air) is manipulated depending on the end goal of the process. Air gasification is completed for energy production while steam gasification of plastics is utilized for the production of syngas, a platform that is used in manufacture of a variety of chemicals such as methanol, liquid fuels, etc. However, in any type of gasification of plastics, the amount of tars in the product gas stream is high, generally higher than that of biomass gasification, and requires a downstream cleanup system to remove the tars. Without this additional unit, the product gas exceeds the industrial acceptable concentration of tars for downstream applications.

Pyrolysis of plastic materials can occur at temperatures in the range of 300-900° C., and is performed in the absence of oxygen to produce liquid oils, a product gas, and plastic char. These oils can be easily further refined into fuels for turbines and diesel engines, or into other chemicals. The product gas from pyrolysis gas a heating value around 30 MJ/kg, which allows for it to be used in energy recovery, often being recycled into the process as a heating source, thus reducing the external demand for energy to maintain operating conditions. Pyrolysis followed by catalytic steam reforming produces a gas stream with a high H₂ production rate, and has the advantage of being free of tars, unlike its gasification counterpart. One disadvantage of the pyrolysis process is that the feedstock needs to be of a uniform size before being introduced into the reactor.

Incineration of plastic materials is considered the baseline case, as it produces energy in the form of heat from the full combustion of plastics in the presence of air but contributes 100% of its carbon content to its carbon footprint. Incineration does allow for the reduction of landfilling, by providing an outlet for energy recovery, however its contribution to climate change is maximum when compared to other processing types, not just other thermal degradation processes. Therefore, in most instances landfilling is preferred to incineration to reduce the amount of emissions released into the atmosphere.

Many different reactor setups are used when processing plastic materials, with the determining factor being the processing route. A fluidized bed reactor provides high heat transfer, has excellent mixing, is easy to regulate temperature, and is easily scaled to meet local processing demands. Dual fluidized bed reactors are employed to further increase the energy recovery of the system by having an air gasification fluidized bed which burns the plastic char to provide energy to the endothermic gasification process. However, challenges present themselves with the low amount of char in plastics (requiring a co-feedstock) and the instability of the heat balance to prevent combustion of the waste plastic feedstock. Additionally, maintaining fluidization is a challenge when processing plastic because as it melts it may form agglomerations, which can cause defluidization of the bed.

Similar to fluidized bed reactors are spouted beds, which have the same advantages as traditional fluidized beds, but are also able to handle larger or irregular shaped feedstock. However, due to the short residence time of the volatile matter, the ability to crack the plastic tars is extremely low, requiring downstream processing for use in synthesis applications.

Having a lower initial investment cost when compared to fluidized bed reactors, fixed bed reactors have much simpler design and operation. Fluidized bed reactors may be suited for small scale processing, but as the required scale increases, fixed bed reactors have poor heat transfer, difficulty operating continuously, and a limited residence time. The use of fixed bed reactors has been generally saved for laboratory use, or in batch processing.

Reactors that have been scarcely used for the thermal degradation of plastics include plasma reactors, updraft reactors, and downdraft reactors. While plasma reactors theoretically can achieve complete cracking of the plastic tars due to the high temperatures reached, their use in industrial settings is not yet proven. In updraft and downdraft reactors, the tar content of waste plastics prevents these types of gasifiers to be used and requires co-gasification in order to maintain continuous operation without tar-related problems.

### SUMMARY

In one aspect, a method for processing plastic material is disclosed. An exemplary method may include providing a feedstock to a first inlet of a first reactor, the feedstock comprising plastic material; providing oxidized oxygen carriers to a second inlet of the first reactor, the oxidized oxygen carriers comprising active material and being provided such that a weight ratio of active material to feedstock is no less than 4:1 and no greater than 10:1; obtaining oxidation products from a first outlet of the first reactor; providing reduced oxygen carriers from a second outlet of the first reactor to a first inlet of the second reactor; providing an oxidizing material to a second inlet of the second reactor; and obtaining energy and/or a second reactor product stream from the second reactor.

In another aspect, a method for processing plastic material is disclosed. An exemplary method may include providing a feedstock to a first inlet positioned near a top portion of a cross-current reactor, the feedstock comprising plastic material; providing oxidized oxygen carriers to a second inlet of the cross-current reactor, the oxidized oxygen carriers comprising active material and being provided such that a weight ratio of active material to feedstock is no less than 4:1 and no greater than 10:1; providing one or more oxygen-source materials to a third inlet positioned near a bottom portion of the cross-current reactor, the one or more oxygen-source materials comprising steam (H₂O), carbon dioxide (CO₂), and/or oxygen (O₂); obtaining syngas from a first outlet positioned near a middle portion of the cross-current reactor, obtaining oxidized oxygen carriers from a second outlet positioned near the bottom portion of the cross-current reactor; and recycling the oxidized oxygen carriers to the second inlet positioned near the top portion of the cross-current reactor.

In another aspect, a reactor system configured to process plastic material is disclosed. An example system may include: a first reactor comprising metal oxide-based redox materials, the metal oxide-based redox materials comprising active material: a first inlet of the first reactor configured to receive a feedstock; a second inlet of the first reactor configured to receive oxidized metal oxide-based redox materials, wherein the active material and the feedstock have a weight ratio no less than 4:1 and no greater than 10:1 in the first reactor; a first outlet of the first reactor configured to provide oxidization products from the first reactor; and a second outlet of the first reactor configured to provide reduced metal oxide-based redox materials to the second reactor; and the second reactor in fluid communication with the first reactor, the second reactor comprising: a first inlet of the second reactor configured to the receive reduced metal oxide-based redox materials from the first reactor; a second inlet of the second reactor configured to receive an oxidizing material; a first outlet of the second reactor configured to provide reduced products from the second reactor; and a second outlet of the second reactor configured to provide oxidized metal oxide-based redox materials.

### BRIEF DESCRIPTION OF THE DRAWINGS

FIG. 1 schematically shows an exemplary system including a co-current first reactor in fluid communication with a co-current second reactor for processing plastic materials.

FIG. 2 schematically shows another exemplary system including a co-current first reactor in fluid communication with a co-current second reactor for processing plastic materials.

FIG. 3 schematically shows another exemplary system including a co-current first reactor in fluid communication with a counter-current second reactor in fluid communication with a riser for processing plastic materials.

FIG. 4 schematically shows another exemplary system including a co-current first reactor in fluid communication with an oxidizer reactor, and the oxidizer reactor in fluid communication with a co-current second reactor in fluid communication with a riser for processing plastic materials.

FIG. 5 schematically shows another exemplary system including a co-current first reactor in fluid communication with a co-current second reactor for processing plastic materials.

FIG. 6 schematically shows another exemplary system including a co-current first reactor in fluid communication with a co-current second reactor for processing plastic materials.

FIG. 7 schematically shows another exemplary system including a counter-current first reactor in fluid communication with a co-current second reactor for processing plastic materials.

FIG. 8 schematically shows another exemplary system including a counter-current first reactor in fluid communication with a counter-current second reactor in fluid communication with a riser for processing plastic materials.

FIG. 9 schematically shows another exemplary system including a pyrolysis reactor in fluid communication with a counter-current first reactor, and the counter-current first reactor in fluid communication with a co-current second reactor for processing plastic materials.

FIG. 10 schematically shows another exemplary system including a counter-current first reactor in fluid communication with an oxidizer reactor, and the oxidizer reactor in fluid communication with a fluidized bed second reactor along with a riser for processing plastic materials.

FIG. 11 schematically shows another exemplary system including a cross-current first reactor in fluid communication with a riser for processing plastic materials.

FIG. 12 schematically shows another exemplary system including a cross-current first reactor in fluid communication with a second reactor in fluid communication with a riser for processing plastic materials.

FIG. 13 schematically shows another exemplary moving bed system for processing plastic materials.

FIG. 14 is a flowchart of a method of operating an exemplary reactor system for processing plastic materials.

FIG. 15 is a flowchart of a method of operating an exemplary reactor system for processing plastic materials.

FIG. 16 shows experimental data of concentration versus time for a reducer outlet gas generated using the system shown in FIG. 15.

FIG. 17 shows experimental temperature programmed oxidation data for particles used in the system shown in FIG. 15.

### DETAILED DESCRIPTION

Systems, methods, and techniques disclosed herein may provide oxidation products, hydrogen gas (H₂), and/or energy generation. Exemplary systems and methods may utilize chemical looping techniques.

Chemical looping is a technology that utilizes an oxygen carrier material for gasification/combustion of feedstocks. The oxygen carrier material donates its lattice oxygen in one reactor to reduce to lower oxidation states while oxidizing the feedstock to oxidation products. The reduced oxygen carriers then flow to a second reactor, wherein they are oxidized by oxidizing materials to complete the loop. Thus, by splitting the combustion/gasification reaction into two separate reactions, the chemical looping system is configured to separate the products from the reactants, thereby averting the downstream separation processes.

Exemplary systems and methods process a feedstock comprising plastic materials, via thermal degradation, into energy or value-added products such as complete or partial oxidation products and/or hydrogen. Exemplary systems and methods may avoid the high tar content typically found in plastics to syngas processes. The plastic material is capable of being in any physical form.

Because of the inherent nature of the moving bed configuration, higher conversion for carbonaceous fuel as well as oxygen carriers can be achieved as compared to a fluidized bed reactor. Because of higher conversions, the moving bed would have smaller reactor size compared to the fluidized bed, leading to a significant decrease in the capital costs. Additionally, the system can be operated at lower solids flowrate leading to reduced attrition of the oxygen carriers, which also reduces the capital cost associated with a moving bed reactor.

Exemplary systems and methods may include an exemplary moving bed reactor that is capable of processing post-consumer waste plastics to partial or full oxidation products, with product purities greater than 70%. The high purity of the resulting product stream may be acceptable for downstream processes without further purification steps. Exemplary systems and methods may contain a range of operating conditions, which provide an advantage to traditional systems and methods since the change in processing demand would not affect downstream units by altering the syngas composition.

Exemplary systems and methods may have lower energy requirements than that of traditional systems and methods for plastic processing. Exemplary systems and methods carry heat via the oxygen carrier particle. Reduced energy requirements were observed for exemplary moving bed reactors, and the total process energy requirements are even less due to the commercially acceptable purity of product stream which forgoes the need for downstream purification.

Exemplary systems and methods may utilize non-renewable heat sources to provide energy for the exemplary systems. In various implementations, renewable energy may be utilized to provide energy to the exemplary systems, where renewable energy may comprise solar energy, biomass/biogas combustion, geothermal energy, electric heating from hydropower, wind power etc. Use of renewable energy may make exemplary systems and methods more sustainable and CO₂ negative. By the use of solar receptacles, solar power can be utilized for supplying heat to the system. By internal or external combustion of biogas/biomass with air, the heat generated can be supplied to the system with/without the use of a heat transfer media.

The exemplary systems mentioned in the disclosure may also be operated autothermally by adjusting the process parameters such as solid circulation rate, oxygen carrier composition, system temperature, gas flowrates, oxygen carrier active material to feed ratio, etc. Exemplary autothermal systems may operate in steady state without any external heat supply needed. The cost of operating an autothermal system are lower, since no additional heat is needed to be supplied to the process during its operation. However, the process parameters for an exemplary autothermal operation may not be optimal for high purity product generation.

### I. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an,” and “the” include plural references unless the context clearly dictates otherwise. The present disclosure also contemplates other embodiments, “comprising,” “consisting of,” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about to about 4” also discloses the range “from 2 to 4.” The term “about” may refer to plus or minus 10% of the indicated number. For example, “about 10%” may indicate a rage of 9% to 11%, and “about 1” may mean from 0.9-1.1. Other meanings of “about” may be apparent from the context, such as rounding off, s, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein.

For each recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.4, 6.5, 6.6, 6.7, 6.8, 6.9, and 7.0 are explicitly contemplated.

A “moving bed reactor” is defined as a reactor where catalytic material flows in a single direction, generally, from top to bottom. The fluid material can flow in the same direction as the catalytic material (co-current movement). The fluid material can flow in an opposite direction (countercurrent movement).

A “fluidized bed reactor” is defined as a reactor where fluid is passed through catalyst material at a sufficient speed to suspend the solid catalyst material. Typically, catalyst material may move in any direction, bounded by the walls of the reactor.

### II. Exemplary Materials

Exemplary systems and methods involve various materials, such plastic materials, oxygen carriers, oxidizing agents, and oxidation products. Examples of each are discussed below.

### A. Exemplary Plastic Materials

Exemplary plastic materials disclosed and contemplated herein are provided as a feedstock to exemplary reactors. Exemplary plastic materials may be introduced as separated, individual streams, or as a mixed stream. Exemplary plastic materials may be provided such that the feed ratios do not result in carbon deposition onto the oxygen carriers.

In some implementations exemplary plastic materials may comprise uniform or non-uniform particle sizes. In various implementations, exemplary plastic materials may comprise pelletized, crushed, shredded, or molten forms. In various implementations, exemplary plastic materials may further comprise large-shredded pieces, small-shredded pieces, mixed size injection, liquefied injection, fine powders, or combinations thereof.

In various implementations, exemplary plastic materials may have a size from 1 micron to 50,000 microns, where “size” may refer to a longest dimension of a plastic material.

In various implementations, exemplary plastic materials may be thermosetting plastics. In various implementations, exemplary plastic materials may be thermoplastic plastics.

In various implementations, exemplary plastic materials may comprise one or more constituents of carbon, hydrogen, oxygen, nitrogen, chlorine, fluorine, sulfur, bromine, or any combinations thereof.

In various implementations, exemplary plastic materials may comprise one or more of non-limiting examples of polyethylene (PE), polyethylene terephthalate (PET), polypropylene, polyvinyl chloride (PVC), polystyrene (PS), polyurethanes, polyesters, epoxy resins, phenolic resins, polyamides, polymethyl methacrylate, furan resins or any combination thereof.

In various implementations, the exemplary plastic materials may contain other carbonaceous species, such as, but not limited to, biomass, coal, petcoke, and municipal solid wastes.

In various implementations, the exemplary carbonaceous species may be added to the plastic materials for modifying the elemental composition of the feedstock.

In various implementations, the exemplary carbonaceous species may be present in the feedstock in concentrations from 0 to 95%.

### B. Exemplary Oxygen Carriers

Exemplary oxygen carriers are described below regarding example components, amounts, and physical properties. Generally, exemplary oxygen carriers are for use in exemplary systems and methods for the processing plastic materials. Typical exemplary oxygen carriers disclosed and contemplated herein include one or more constituents which comprise one or more metal oxide components and one or more support materials.

Exemplary oxygen carriers typically have the capability of effectively activating the C—H bond of the plastic materials and decomposing into, at least, carbon and hydrogen gas (H₂).

In various implementations, the carbon and hydrogen gas (H₂) may further react with the oxygen carrier to produce CO, CO₂, H₂O, and/or remain unconverted.

Exemplary oxygen carriers may change their oxidation state based on, at least, interaction with reducing and oxidizing gases. Exemplary oxygen carriers may provide heat transfer throughout the various exemplary reactors described herein.

Exemplary oxygen carriers may provide for high heat-carrying capacity based on, at least, one or more active metal oxides (i.e., redox material) and one or more support metal oxides (i.e., an inert material), thereby providing a heat balance across the exemplary systems.

### 1. Exemplary Chemical Constituents

Exemplary oxygen carriers may comprise one or more active metal oxides. In various implementations, the one or more active metal oxides comprises transition metal oxides such as, but not limited to, iron oxide, copper oxide, nickel oxide, manganese oxide, cobalt oxide, or any combination thereof.

Exemplary oxygen carriers may comprise of metal oxides and/or metal oxide derivatives that are capable of undergoing cyclic reduction and oxidation, thereby providing a change in the oxidation state of one or more constituents present in the exemplary oxygen carriers.

In various implementations, the one or more active metal oxides may comprise 5 weight percent (wt %) to 95 wt % of the total weight of the exemplary oxygen carriers. In various implementations, the one or more active metal oxides may comprise 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt %. In various implementations, the one or more active metal oxides may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary oxygen carriers. In various implementations, the one or more active metal oxides may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary oxygen carriers.

Exemplary oxygen carriers may comprise one or more support metal oxides. In various implementations, the one or more support metal oxides may comprise any known metal oxide in the art. In various implementations, the one or more support metal oxides may comprise SiO₂, SiC, Al₂O₃, MgO, CaO, alumina-silicates, ceramics, clay supports like kaolin and bentonite, alumina-zirconia-silica, or a combination comprising of two or more support materials.

In various implementations, the one or more support metal oxides may comprise 5 wt % to 95 wt % of the total weight of the exemplary oxygen carriers. In various implementations, the one or more support metal oxides may comprise 10 wt % to 95 wt %; 15 wt % to 95 wt %; 20 wt % to 95 wt %; 25 wt % to 95 wt %; 30 wt % to 95 wt %; 35 wt % to 95 wt %; 40 wt % to 95 wt %; 45 wt % to 95 wt %; 50 wt % to 95 wt %; 55 wt % to 95 wt %; 60 wt % to 95 wt %; 65 wt % to 95 wt %; 70 wt % to 95 wt %; 75 wt % to 95 wt %; 80 wt % to 95 wt %; 85 wt % to 95 wt %; 90 wt % to 95 wt %; 5 wt % to 90 wt %; 5 wt %; to 85 wt %; 10 wt % to 85 wt %; 15 wt % to 85 wt %; 20 wt % to 85 wt %; 20 wt % to 80 wt %; 25 wt % to 80 wt %; 25 wt % to 75 wt %; 30 wt % to 75 wt %; 30 wt % to 70 wt %; 35 wt % to 70 wt %; 35 wt % to 65 wt %; 40 wt % to 65 wt %; 40 wt % to 60 wt %; 45 wt % to 60 wt %; 45 wt % to 55 wt %; or about 50 wt %. In various implementations, the one or more support metal oxides may comprise no less than 5 wt %; no less than 15 wt %; no less than 25 wt %; no less than 35 wt %; no less than 45 wt %; no less than 55 wt %; no less than 65 wt %; no less than 75 wt %; or no less than 85 wt % of the total weight of the exemplary oxygen carriers. In various implementations, the one or more support metal oxides may comprise no greater than 95 wt %; no greater than 90 wt %; no greater than 80 wt %; no greater than 70 wt %; no greater than 60 wt %; no greater than 50 wt %; no greater than 40 wt %; no greater than 30 wt %; no greater than 20 wt %; or no greater than 10 wt % of the total weight of the exemplary oxygen carriers.

In various implementations, the one or more dopants and promoters may provide active sites for adsorption of reactant gas molecules. In various implementations, the one or more dopants and promoters may provide additional oxygen vacancies in the lattice of exemplary oxygen carriers, thereby improving the rates of ionic diffusion and lowering the activation energy barrier for product formation.

In various implementations, the one or more promoters and dopants may comprise oxide, metallic, and other derivatives of elements including, but not limited to, Na, Li, K, Mg, Ca, Sr, Ba, Ce, La, Be, Ni, Co, Cu, Sc, Ti, V, Cr, Mn, Zn, Y, Zr, Nb, Mo, Tc, Ru, Rh, Pd, Ag, Cd, Lu, Hf, Ta, W, Re, Os, Ir, Pt, Au, or combinations thereof

### 2. Physical Properties

Exemplary oxygen carriers have sufficient strength to withstand the transport between reactors. Various physical properties of exemplary oxygen carriers, such as crushing mechanical strength, may be determined using methods disclosed in “Chemically and physically robust, commercially-viable iron-based composite oxygen carriers sustainable over 3000 redox cycles at high temperatures for chemical looping applications,” Chung et. al, Energy Environ. Sci., 2017, 10, 2318-2323, incorporated herein by reference in its entirety.

In various implementations, exemplary oxygen carriers have a crushing mechanical strength between 1 MPa 200 MPa; 5 MPa to 200 MPa; 10 MPa to 200 MPa; 15 MPa to 200 MPa; 20 MPa to 200 MPa; 25 MPa to 200 MPa; 30 MPa to 200 MPa; 40 MPa to 200 MPa; 50 MPa to 200 MPa; 60 MPa to 200 MPa; 70 MPa to 200 MPa; 80 MPa; to 200 MPa; 90 MPa to 200 MPa; 100 MPa to 200 MPa; 120 MPa; to 200 MPa; 140 MPa to 200 MPa; or 150 MPa to 200 MPa. In various implementations, exemplary oxygen carriers have a crushing mechanical strength of no less than 1 MPa; no less than 5 MPa; no less than 15 MPa; no less than 25 MPa; no less than 35 MPa; no less than 45 MPa; no less than 75 MPa; no less than 95 MPa; no less than 125 MPa; no less than 155 MPa; no less than 175 MPa; or no less than 195 MPa. In various implementations, exemplary oxygen carriers have a crushing mechanical strength of no greater than 200 MPa; no greater than 180 MPa; no greater than 160 MPa; no greater than 140 MPa; no greater than 120 MPa; no greater than 100 MPa; no greater than 90 MPa; no greater than 80 MPa; no greater than 70 MPa; no greater than 60 MPa; no greater than 50 MPa; no greater than 40 MPa; no greater than 30 MPa; no greater than 20 MPa; no greater than 10 MPa; or no greater than 5 MPa.

In various implementations, exemplary oxygen carriers may have a particle size from 0.01 mm to 5 mm. As used herein, “particle size” may refer to a median particle size. As used herein, the size may refer to a longest dimension of the particle. In various implementations, exemplary oxygen carriers may have a particle size from 0.01 mm to 5 mm; 0.02 mm to 5 mm; 0.03 mm to 5 mm; 0.04 mm to 5 mm; 0.05 mm to 5 mm; 0.06 mm to 5 mm; 0.07 mm to 5 mm; 0.08 mm to 5 mm; 0.09 mm to 5 mm; 0.1 mm to 5 mm; 0.5 mm to 5 mm; 0.8 mm to 5 mm; 1 mm to 5 mm; 1 mm to 4.5 mm; 1.2 mm to 4.5 mm; 1.5 mm to 4.5 mm; 1.5 mm to 4 mm; 1.8 mm to 4 mm; 2 mm to 4 mm; 2 mm to 3.5 mm; 2.5 mm to 3.5 mm; or about 3 mm. In various implementations, exemplary oxygen carriers may have a particle size of no less than 0.01 mm; no less than 0.02 mm; no less than 0.03 mm; no less than 0.04 mm; no less than 0.05 mm; no less than 0.06 mm; no less than 0.07 mm; no less than 0.08 mm; no less than 0.09 mm; no less than 0.1 mm; no less than 0.3 mm; no less than 0.5 mm; no less than 0.7 mm; no less than 0.9 mm; no less than 1.1 mm; no less than 1.3 mm; no less than 1.5 mm; no less than 1.7 mm; no less than 1.9 mm; no less than 2.1 mm; no less than 2.3 mm; no less than 2.5 mm; no less than 2.7 mm; no less than 2.9 mm; no less than 3.1 mm; no less than 3.3 mm; no less than 3.7 mm; no less than 3.9 mm; no less than 4.1 mm; no less than 4.3 mm; no less than 4.5 mm; no less than 4.7 mm; or no less than 4.9 mm. In various implementations, exemplary oxygen carries may have a particle size of no greater than 5 mm; no greater than 4.8 mm; no greater than 4.6 mm; no greater than 4.4 mm; no greater than 4.2 mm; no greater than 4 mm; no greater than 3.8 mm; no greater than 3.6 mm; no greater than 3.4 mm; no greater than 3.2 mm; no greater than 3 mm; no greater than 2.8 mm; no greater than 2.6 mm; no greater than 2.4 mm; no greater than 2.2 mm; no greater than 2 mm; no greater than 1.8 mm; no greater than 1.6 mm; no greater than 1.4 mm; no greater than 1.2 mm; no greater than 1 mm; no greater than 0.8 mm; no greater than 0.6 mm; no greater than 0.4 mm; no greater than 0.2 mm; no greater than 0.08 mm; no greater than 0.06 mm; no greater than 0.04 mm; or no greater than 0.02 mm.

In various implementations, exemplary oxygen carriers may have a particle density from 1000-5000 kg/m³. In various implementations, exemplary oxygen carriers may have a particle density from 1000 kg/m³ to 4900 kg/m³; 1000 kg/m³ to 4800 kg/m³; 1000 kg/m³ to 4700 kg/m³; 1000 kg/m³ to 4600 kg/m³; 1000 kg/m³ to 4500 kg/m³; 1100 kg/m³ to 4500 kg/m³; 1200 kg/m³ to 4500 kg/m³; 1300 kg/m³ to 4500 kg/m³; 1400 kg/m³ to 4500 kg/m³; 1500 kg/m³ to 4500 kg/m³; 1600 kg/m³ to 4500 kg/m³; 1700 kg/m³ to 4500 kg/m³; 1800 kg/m³ to 4500 kg/m³; 1900 kg/m³ to 4500 kg/m³; 2000 kg/m³ to 4500 kg/m³; 2000 kg/m³ to 4000 kg/m³; 2500 kg/m³ to 4000 kg/m³; 2500 kg/m³ to 3500 kg/m³; or about 3000 kg/m³. In various implementations, exemplary oxygen carriers may have a particle density of no less than 1000 kg/m³; no less than 1200 kg/m³; no less than 1400 kg/m³; no less than 1600 kg/m³; no less than 1800 kg/m³; no less than 2000 kg/m³; no less than 2200 kg/m³; no less than 2400 kg/m³; no less than 2600 kg/m³; no less than 2800 kg/m³; no less than 3000 kg/m³; no less than 3200 kg/m³; no less than 3400 kg/m³; no less than 3600 kg/m³; no less than 3800 kg/m³; no less than 4000 kg/m³; no less than 4200 kg/m³; no less than 4400 kg/m³; no less than 4600 kg/m³; or no less than 4800 kg/m³. In various implementations, exemplary oxygen carriers may have a particle density of no greater than 5000 kg/m³; no greater than 4900 kg/m³; no greater than 4700 kg/m³; no greater than 4500 kg/m³; no greater than 4300 kg/m³; no greater than 4100 kg/m³; no greater than 3900 kg/m³; no greater than 3700 kg/m³; no greater than 3500 kg/m³; no greater than 3300 kg/m³; no greater than 3100 kg/m³; no greater than 2900 kg/m³; no greater than 2700 kg/m³; no greater than 2500 kg/m³; no greater than 2300 kg/m³; no greater than 2100 kg/m³; no greater than 1900 kg/m³; no greater than 1700 kg/m³; no greater than 1500 kg/m³; or no greater than 1300 kg/m³.

### C. Exemplary Oxidizing Materials

Generally, exemplary oxidizing materials may be used for the oxidization of reduced oxygen carriers. Exemplary oxidizing materials may regenerate reduced oxygen carriers, thereby providing oxidized oxygen carriers.

Exemplary oxidizing materials may comprise compounds that include one or more oxygen atoms. In various implementations, exemplary oxidizing materials may comprise steam (H₂O), air, oxygen (O₂), carbon dioxide (CO₂), and combinations thereof.

### D. Exemplary Oxidation Products

Generally, exemplary oxidation products are the products of an exemplary first reactor, which may be a moving bed reducer reactor.

In various implementations, exemplary oxidation products may comprise completely oxidized products, partially oxidized products, or upgraded syngas. In various implementations, partial oxidation products may comprise syngas (e.g., hydrogen gas (H₂) and carbon monoxide (CO)). In various implementations, complete oxidation products comprise carbon dioxide (CO₂) and water (H₂O). In various implementations, upgraded syngas comprises hydrogen gas (H₂) and carbon monoxide (CO) and is substantially free of tar. Substantially free of tar, as used herein, means no greater than 50 g/Nm³; no greater than 45 g/Nm³; no greater than 40 g/Nm³; no greater than 30 g/Nm³; no greater than 25 g/Nm³; no greater than 10 g/Nm³; no greater than 5 g/Nm³; no greater than 1 g/Nm³; no more than 0.5 g/Nm³, or no more than 0.05 g/Nm³.

### III. Exemplary Systems

Various exemplary systems for processing plastic materials are described below. The various exemplary systems disclosed and contemplated herein may be scaled without reducing the performance of the exemplary systems.

In various implementations, due to the inherent nature of the moving bed configuration, higher conversion for carbonaceous fuel as well as oxygen carriers can be achieved as compared to a fluidized bed reactor. Because of higher conversions, the moving bed would have a smaller reactor size compared to the fluidized bed, leading to a decrease in the capital costs. Additionally, the system can be operated at lower solids flowrates, leading to reduced attrition of the oxygen carriers, which also reduces the capital cost associated with moving bed reactors.

In various implementations, a feedstock is provided to the exemplary systems such that there is sufficient mixing within an exemplary first reactor to prevent large agglomerations from forming. Exemplary systems may prevent large agglomerations from forming by employing multiple injection ports along the circumference of the exemplary first reactor, and/or adding baffles near the injection ports. In various implementations, the inlets of exemplary systems may have various sizes to accommodate large, irregular shaped feedstocks. It was observed that the size of the plastic materials had no effect on the performance of exemplary system disclosed and contemplated herein.

In various implementations, the fluid communication of gases and solids between the one or more inlets and one or more outlets of the exemplary reactors may be established by using mechanical and/or non-mechanical devices that are commonly used in the art. In various implementations, the mechanical and/or non-mechanical devices include, but not limited to, L-Valve, J-Valve, loop seal, seal port, ball valve, gate valve or combinations thereof. In some implementations, an additional fluid stream may be introduced to assist in establishing fluid communication between the one or more inlets and the one or more outlets of the exemplary reactors within the exemplary system.

In some instances, exemplary systems may comprise one or more dehalogenation units. Exemplary dehalogenation units may be configured to remove at least one of chlorine (Cl⁻) ions, bromine (Br⁻) ions, or fluorine (F⁻) ions from the feedstock prior to introduction of the feedstock to a first reactor.

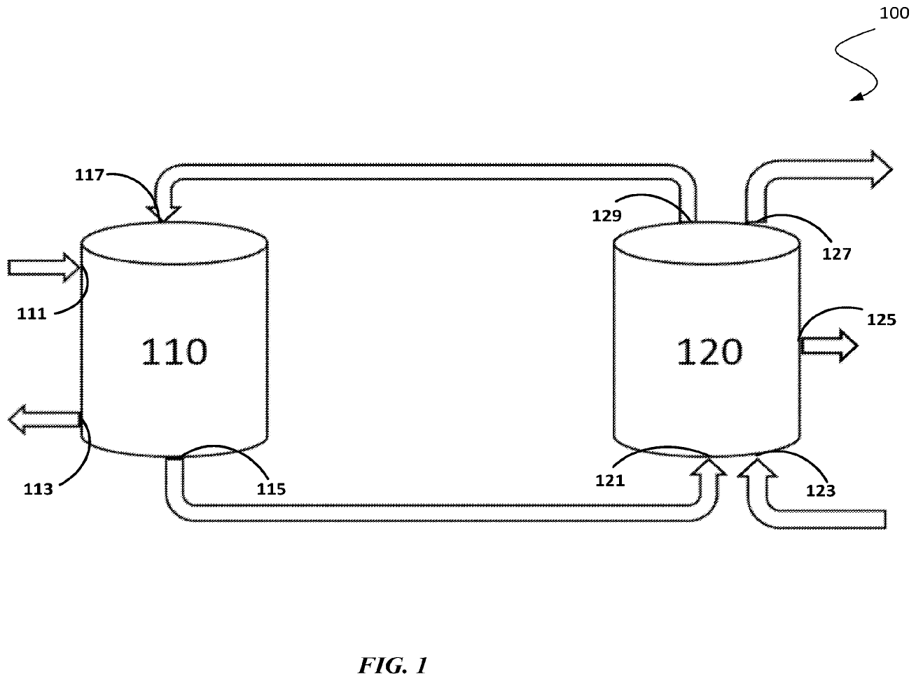

FIG. 1 shows an exemplary system 100 for processing plastic material. System 100 comprises co-current first reactor 110 and co-current second reactor 120, which are in fluid communication with each other. Co-current first reactor 110 includes first inlet 111 and second inlet 117, such that co-current first reactor 110 is arranged to operate in co-current flow fashion. Co-current first reactor 110 further includes first outlet 113 and second outlet 115 which is in fluid communication with co-current second reactor 120. Co-current second reactor 120 includes first inlet 121 and second inlet 123, such that co-current second reactor 120 is arranged to operate in co-current flow fashion. Co-current second reactor 120 further includes first outlet 129 which is in fluid communication with co-current first reactor 110, second outlet 127, and heat transfer 127.

As shown, a feedstock is fed into the first inlet 111 of co-current first reactor 110, where the feedstock comprises plastic material. Typically, co-current first reactor 110 is configured as a moving bed reactor.

In various implementations, the feedstock is catalytically decomposed using oxygen carriers in co-current first reactor 110 to form oxidized products. The oxygen carriers in co-current first reactor 110 crack higher hydrocarbons into syngas, carbon dioxide (CO₂), and steam (H₂O). In various implementations, the reaction of cracking higher hydrocarbons into syngas, carbon dioxide (CO₂), and steam (H₂O) reduces the formation of tars which may cause issues in downstream processing equipment such as, but not limited to, fouling and damage to sensitive operation instrumentation or poisoning of the oxygen carriers in downstream operations. As shown, the oxidized products are provided from the first outlet 113 of co-current first reactor 110.

The oxygen carriers undergo reduction by the loss of lattice oxygen during the oxidation of the feedstock in co-current first reactor 110. As shown, the second outlet 115 of co-current first reactor 110 is in fluid communication with the first inlet 121 of co-current second reactor 120, where the reduced oxygen carriers are provided from the second outlet 115 to the first inlet 121.

Co-current second reactor 120 may be configured as a moving bed reactor or a fluidized bed reactor. As shown, oxidizing material is provided to the second inlet 123 of co-current second reactor 120. The oxidizing material regenerates the reduced oxygen carriers in co-current second reactor 120.

In various implementations, the regeneration occurring in co-current second reactor 120 may generate thermal energy. As shown, the thermal energy is obtained from co-current second reactor 120 by energy transfer 125.

In various implementations, energy transfer 125 may comprise utilizing a heat transfer fluid. In various implementations, energy is obtained by combination of exemplary internal and external heat transfer mechanisms. Exemplary internal heat transfer mechanism may include jacketing the walls of the co-current second reactor 120 with a heat transfer media, or through an internal heat transfer coil, wherein the heat transfer media passes through the coil and performs heat transfer with the co-current second reactor 120 exemplary reactants and products. Exemplary external heat transfer mechanisms may include heat transfer across the inlets and/or the outlets of the co-current second reactor 120. The co-current second reactor 120 may be operated to perform heat integration across the exemplary system 100 or throughout a chemical and/or physical plant.

As shown, reduced products are provided from the second outlet 127 of co-current second reactor 120.

As shown, the first outlet 129 of co-current second reactor 120 is in fluid communication with the second inlet 117 of co-current first reactor 110, where oxidized oxygen carriers, after undergoing regeneration, are provided from the first outlet 129 to the second inlet 117.

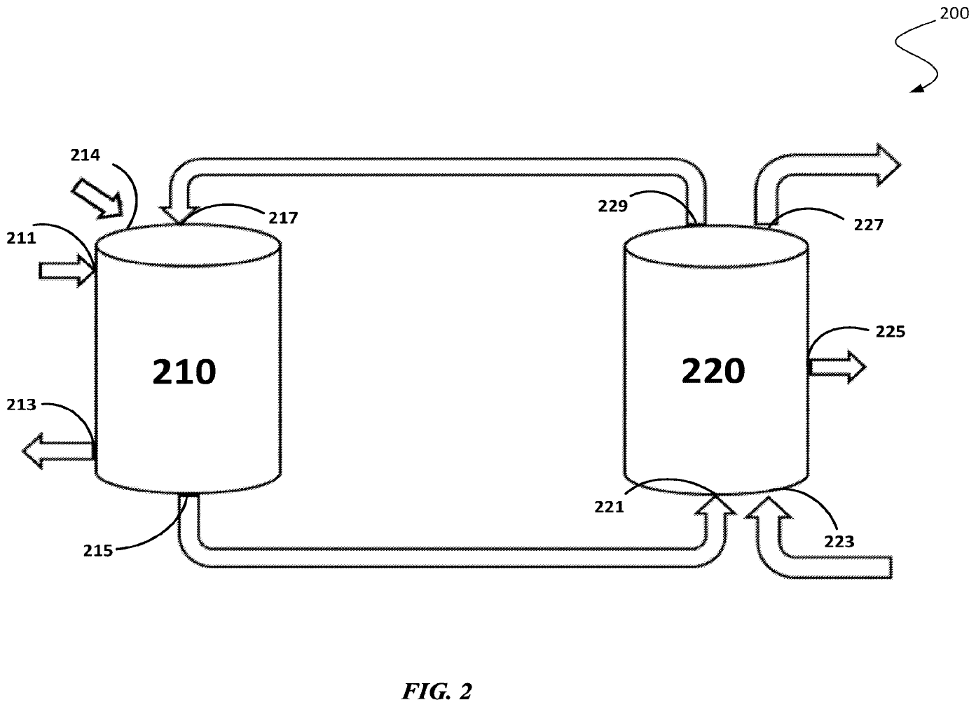

FIG. 2 shows exemplary system 200 for processing plastic material. Unless otherwise indicated, and for the sake of brevity, components in FIG. 2 have the same or similar arrangement and operation as those similarly numbered in system 100 shown in FIG. 1. System 200 also comprises third inlet 214 into co-current first reactor 210.

As shown, oxygen-source materials are provided to a third inlet 214 of co-current first reactor 210. In various implementations, the oxygen-source materials comprise one or more of steam (H₂O), carbon dioxide (CO₂) and/or oxygen (O₂).

In various implementations, the feedstock is catalytically decomposed using oxygen carriers in co-current first reactor 210 to form syngas. The oxygen carriers in co-current first reactor 210 crack higher hydrocarbons into syngas. As shown, the syngas is provided from the first outlet 213 of co-current first reactor 210.

As shown, air is provided to the second inlet 223 of co-current second reactor 220. In various implementations, the air regenerates the reduced oxygen carriers in co-current second reactor 220.

As shown, depleted air is provided from the second outlet 227 of co-current second reactor 220.

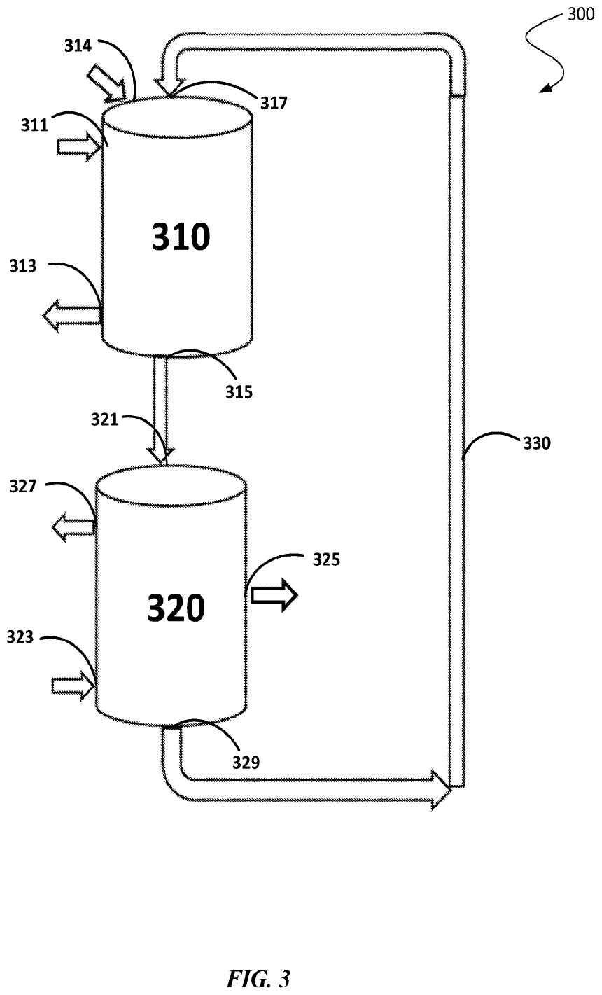

FIG. 3 shows an exemplary system 300 for processing plastic material. Unless otherwise indicated, and for the sake of brevity, components in FIG. 3 have the same or similar arrangement and operation as those similarly numbered in system 200 shown in FIG. 2. In system 300, reactor 320 is arranged as a counter-current reactor, whereas reactor 220 is co-current in system 200. System 300 also comprises riser 330, which is in fluid communication with co-current first reactor 310 and counter-current second reactor 320.

As shown, the reduced products are provided from the second outlet 327 of counter-current second reactor 320.

As shown, the first outlet 329 of counter-current reactor 320 is in fluid communication with riser 330, and riser 330 is in fluid communication with the second inlet 317 of co-current first reactor 310. As shown, the oxidized oxygen carriers, after undergoing regeneration, are pneumatically provided from the first outlet 329 to the second inlet 317.

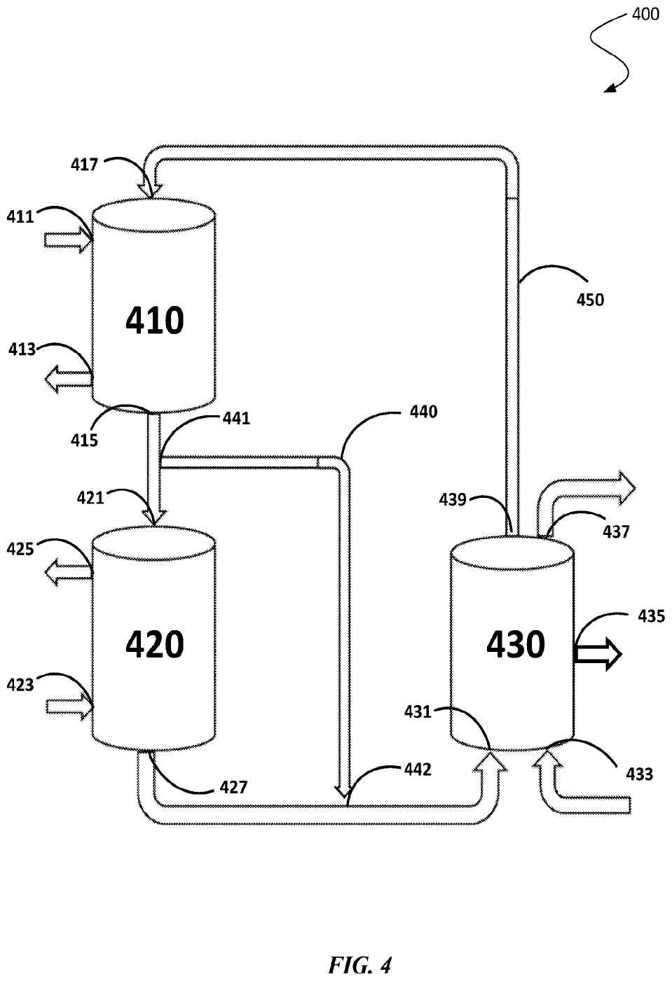

FIG. 4 shows an exemplary system 400 for processing plastic material. System 400 comprises co-current first reactor 410 in fluid communication with oxidizer reactor 420, and oxidizer reactor 420 is in fluid communication with co-current second reactor 430. Co-current second reactor 430 is in fluid communication with riser 450, and riser 450 is in fluid communication with co-current first reactor 410. Additionally, system 400 comprises a bypass stream 440 which is in fluid communication with co-current first reactor 410 and co-current second reactor 430. Co-current first reactor 410 includes first inlet 411 and second inlet 417, such that co-current first reactor 410 is arranged to operate in co-current flow fashion. Co-current first reactor 410 further includes first outlet 413 and second outlet 415 which is in fluid communication with oxidizer reactor 420. Oxidizer reactor 420 includes top inlet 421, bottom inlet 423, top outlet 425, and bottom outlet 427 which is in fluid communication with co-current second reactor 430. Co-current second reactor 430 includes first inlet 431 and second inlet 433, such that co-current second reactor 430 is arranged to operate in co-current flow fashion. Co-current second reactor 430 further includes first outlet 439 in fluid communication with riser 450, second outlet 437, and energy transfer 435.

As shown, a feedstock is fed into the first inlet 411 of co-current first reactor 410, where the feedstock comprises plastic material. In various implementations, co-current first reactor 410 may be configured as a moving bed reactor.

In various implementations, the feedstock is catalytically decomposed using oxygen carriers in co-current first reactor 410 to form syngas. The oxygen carriers in co-current first reactor 410 crack higher hydrocarbons into syngas. As shown, the syngas is provided from the first outlet 413 of co-current first reactor 410.

In various implementations, the oxygen carriers undergo reduction by the loss of lattice oxygen during the oxidation of the feedstock in co-current first reactor 410. As shown, second outlet 415 of co-current first reactor 410 is in fluid communication with the first inlet 421 of oxidizer reactor 420, where the reduced oxygen carriers are provided from the second outlet 415 to the first inlet 421. In various implementations, oxidizer reactor 420 may be configured as a moving bed reactor.

As shown, steam (H₂O) is provided to the bottom inlet 423 of oxidizer reactor 420. In various implementations, the steam reacts with the reduced oxygen carriers in oxidizer reactor 420 to generate hydrogen gas (H₂) and partially reduced oxygen carriers. As shown, hydrogen gas (H₂) is provided from the top outlet 425 of oxidizer reactor 420. As shown, the bottom outlet 427 is in fluid communication with the first inlet 431 of co-current second reactor 430, where the partially reduced oxygen carriers are provided from the bottom outlet 427 to the first inlet 431.

In various implementations, the relative temperature change of the oxidizer reactor 420 may be between 0° C. to 100° C., which may result in better kinetics for the generation of hydrogen gas (112).

Bypass stream 440 enables reduced oxygen carriers to pass from co-current first reactor 410 to co-current second reactor 430, thereby bypassing oxidizer reactor 420. Various configurations of bypass stream 440 are possible.

For example, bypass stream 440 may split a stream of reduced oxygen carriers, shown as bypass inlet 441, and direct a given percentage to merge with an output from oxidizer reactor 420, which occurs at bypass outlet 442.

The given percentage diverted around oxidizer reactor may be varied. For example, a percentage of reduced oxygen carriers diverted may be no less than 1%; no less than 10%; no less than 20%; no less than 30%; no less than 40%; no less than 50%; no less than 60%; no less than 70%; no less than 80%; or no less than 90%. For example, a percentage of reduced oxygen carriers diverted may be no greater than 90%; no greater than 80%; no greater than 70%; no greater than 60%; no greater than 50%; no greater than 40%; no greater than 30%; no greater than 20%; no greater than 10%; or no greater than 1%.

As another example, bypass stream 440 may have a dedicated outlet from co-current reactor 410 which leads to bypass outlet 442. As another example, bypass stream 440 may lead from bypass inlet 441 into an inlet of co-current reactor 430. As another example, bypass stream 440 may be a direct fluid connection between an outlet of co-current reactor 410 and an inlet of co-current reactor 430.

In various implementations, the splitting of the reduced oxygen carriers between the oxidizer reactor 420 and the bypass stream 440 may provide for better production of hydrogen gas (H₂) in the oxidizer reactor 420, whereas the steam to iron (H₂O:Fe) ratio increases the production of hydrogen gas (H₂).

In various implementations, the partially reduced and reduced oxygen carriers undergo reduction by the loss of lattice oxygen during the oxidation of the feedstock in co-current second reactor 430. As shown, partially reduced oxygen carriers and reduced oxygen carriers are provided to first inlet 431 of co-current second reactor 430. In various implementations, co-current second reactor 430 may be configured as a fluidized bed reactor.

As shown, air is provided to the second inlet 433 of co-current second reactor 430. In various implementations, the air regenerates the partially reduced oxygen carriers (those provided from oxidizer reactor 420) and the reduced oxygen carriers (those provided from the co-current first reactor 410 by the bypass stream 440) in co-current second reactor 430.

In various implementations, the regeneration occurring in co-current second reactor 430 generates thermal energy. As shown, thermal energy is obtained from co-current second reactor 430 by energy transfer 435. In various implementations, energy transfer 435 comprises utilizing a energy transfer fluid.

As shown, depleted air is provided from the second outlet 437 of co-current second reactor 430.

As shown, the first outlet 439 is in fluid communication with riser 450, and riser 450 is in fluid communication with the second inlet 417 of co-current first reactor 410. As shown, the oxidized oxygen carriers, after undergoing regeneration, are pneumatically provided from the first outlet 439 to the second inlet 417.

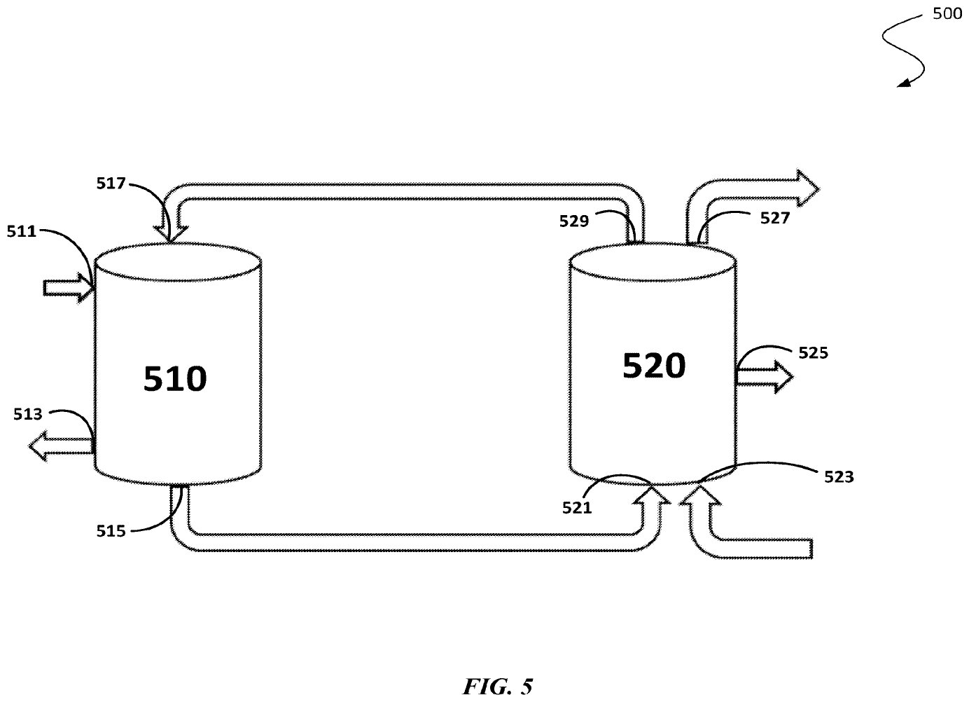

FIG. 5 shows an exemplary system 500 for processing syngas. Unless otherwise indicated, and for the sake of brevity, components in FIG. 5 have the same or similar arrangement and operation as those similarly numbered in system 100 shown in FIG. 1.

As shown, a feedstock is fed into the first inlet 511 of co-current first reactor 510, where the feedstock comprises syngas that includes tars. In various implementations, co-current first reactor 510 may be configured as a moving bed reactor.

In various implementations, the feedstock is catalytically decomposed using oxygen carriers in co-current first reactor 510 to form syngas. The oxygen carriers in co-current first reactor 510 crack higher hydrocarbons into syngas. As shown, the syngas is provided from the first outlet 513 of co-current first reactor 510.

In various implementations, the oxygen carriers undergo reduction by the loss of lattice oxygen during the oxidation of the feedstock in co-current first reactor 510. As shown, the second outlet 515 of co-current first reactor 510 is in fluid communication with the first inlet 521 of co-current second reactor 520, where the reduced oxygen carriers are provided from the second outlet 515 to the first inlet 521. In various implementations, co-current second reactor 520 may be configured as a fluidized bed reactor.

As shown, air is provided to the second inlet 523 of co-current second reactor 520. In various implementations, the air regenerates the reduced oxygen carriers in co-current second reactor 520.

As shown, depleted air is provided from the second outlet 527 of co-current second reactor 520.

In various implementations, the system 500 is in fluid communication with pre-existing chemical or physical processes. In various implementations, the syngas product stream of the pre-existing chemical or physical processes, is fed as the feedstock to the first inlet 511 of co-current first reactor 510.

In various implementations, the pre-existing chemical or physical processes utilize thermal degradation to process plastic materials. In various implementations, the challenge of the pre-existing chemical or physical processes is the presence of tars, which prevents the syngas from being commercially usable and/or saleable. In various implementations, the present disclosure of system 500 provides for increasing the amount of syngas available for sale and reducing the costs in comparison to currently commercially available systems and methods.

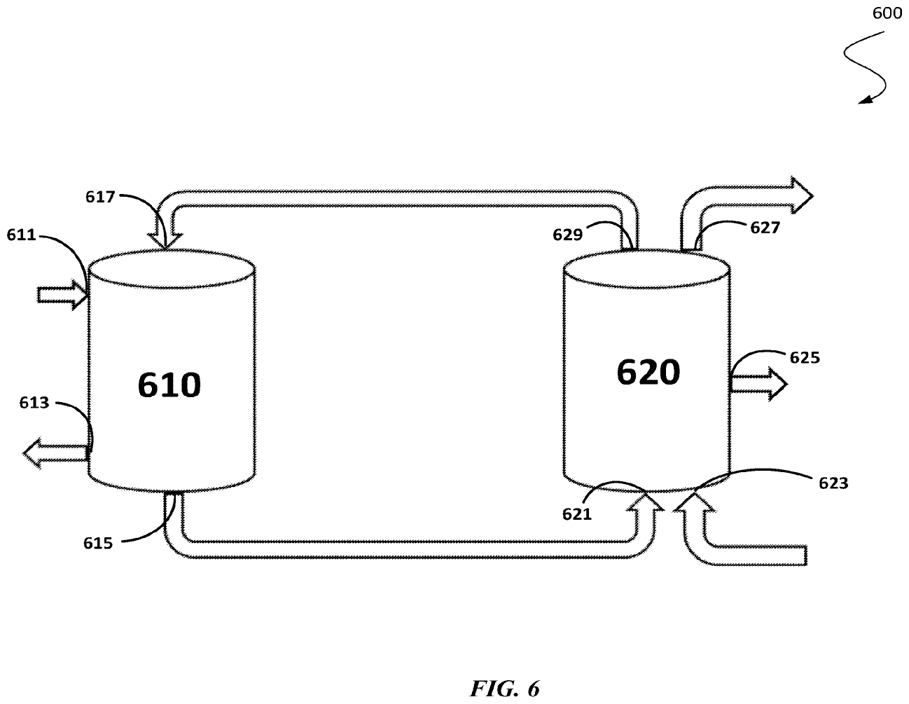

FIG. 6 shows an exemplary system 600 for processing plastic material. Unless otherwise indicated, and for the sake of brevity, components in FIG. 6 have the same or similar arrangement and operation as those similarly numbered in system 100 shown in FIG. 1.

As shown, steam (H₂O) is provided to the second inlet 623 of co-current second reactor 620. In various implementations, the steam (H₂O) regenerates the reduced oxygen carriers in co-current second reactor 620.

As shown, hydrogen gas (H₂) and unreacted steam (H₂O) is provided from the second outlet 627 of co-current second reactor 620.

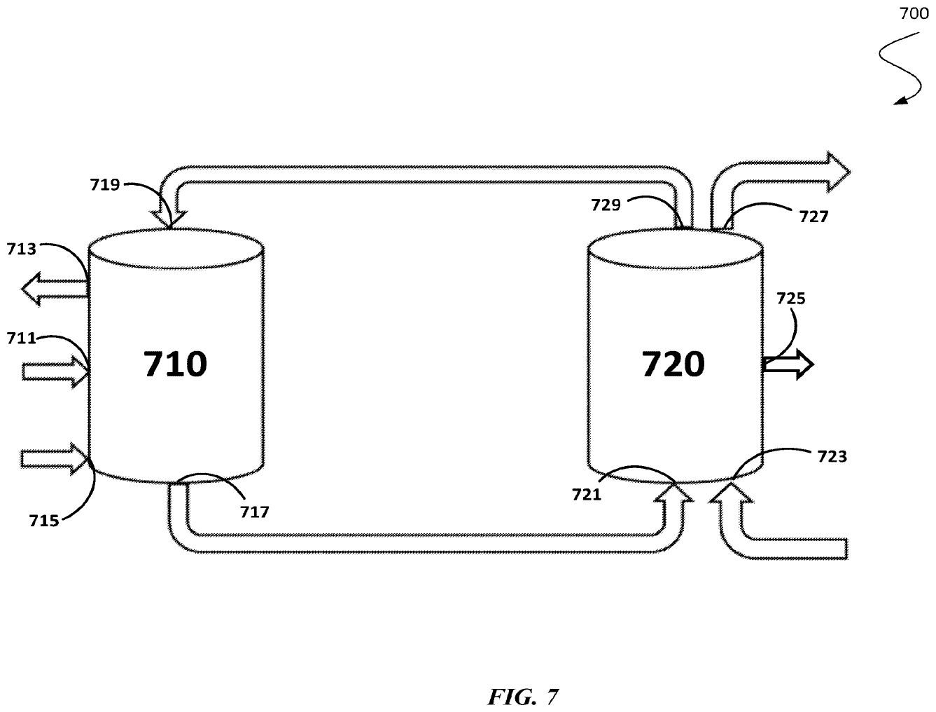

FIG. 7 shows an exemplary system 700 for processing plastic material. System 700 comprises counter-current first reactor 710 in fluid communication with co-current second reactor 720, co-current second reactor 720 is in fluid communication with counter-current first reactor 710. Counter-current first reactor 710 includes first inlet 711, second inlet 719, and third inlet 715, such that counter-current first reactor 710 is arranged in counter-current flow fashion. Counter-current first reactor 710 further includes first outlet 713 and second outlet 717 which is in fluid communication with co-current second reactor 720. Co-current second reactor 720 includes first inlet 721 and second inlet 723, such that co-current second reactor 720 is arranged to operate in co-current flow fashion. Co-current second reactor 720 further includes first outlet 729 which is in fluid communication with counter-current first reactor 710, second outlet 727, and energy transfer 725.

As shown, a feedstock is fed into the first inlet 711 at a middle portion of counter-current first reactor 710, where the feedstock comprises plastic material. In various implementations, where the feedstock is provided to the middle portion of counter-current first reactor 710 the feedstock may undergo devolatilization at temperatures between 500° C. to 1200° C., more specifically between 700 to 1100° C. In various implementations, volatile components of the feedstock travel counter-currently in counter-current first reactor 710, and char flows co-currently with the oxygen carriers in counter-current first reactor 710. In various implementations, providing the feedstock at the middle portion of counter-current first reactor 710 may provide full conversion of the plastics, thereby maximizing the reduction of the oxygen carriers. In various implementations, counter-current first reactor 710 may be configured as a moving bed reactor.

As shown, oxygen-source materials are provided to the third inlet 715 of counter-current first reactor 710. In various implementations, the oxygen-source materials comprise one or more of steam (H₂O) and/or carbon dioxide (CO₂).

In various implementations, the feedstock is catalytically decomposed using oxygen carriers in counter-current first reactor 710 to form completely oxidized products. The oxygen carriers in counter-current first reactor 710 crack higher hydrocarbons into completely oxidized product components. As shown, the completely oxidized products are provided from the first outlet 713 of counter-current first reactor 710.

In various implementations, the oxygen carriers undergo reduction by the loss of lattice oxygen during the oxidation of the feedstock in counter-current first reactor 710. As shown, the second outlet 717 of counter-current first reactor 710 is in fluid communication with the first inlet 721 of co-current second reactor 720, where the educed oxygen carriers are provided from the second outlet 717 to the first inlet 721. In various implementations, co-current second reactor 720 may be configured as a moving bed reactor or a fluidized bed reactor.

As shown, air is provided to the second inlet 723 of co-current second reactor 720. In various implementations, the air regenerates the reduced oxygen carriers in co-current second reactor 720.

In various implementations, the regeneration occurring in co-current second reactor 720 generates thermal energy. As shown, the thermal energy is obtained from co-current second reactor 720 by energy transfer 725. In various implementations, energy transfer 725 comprises a heat transfer fluid.

As shown, depleted air is provided from the second outlet 727 of co-current second reactor 720.

As shown, the first outlet 729 of co-current second reactor 720 is in fluid communication with the second inlet 719 of counter-current first reactor 710, where the oxidized oxygen carriers are provided from the first outlet 729 and the second inlet 719.

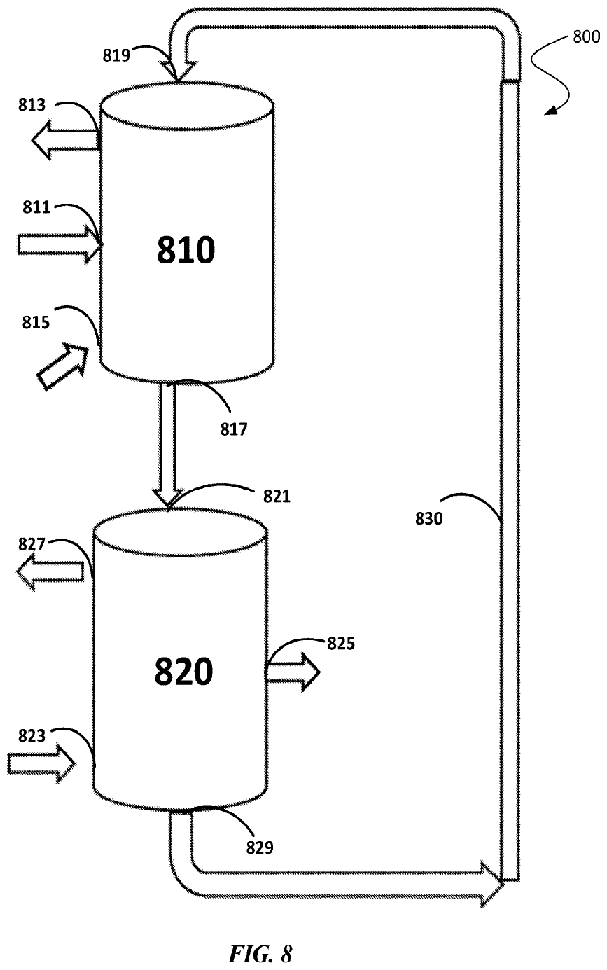

FIG. 8 shows an exemplary system 800 for processing plastic material. Unless otherwise indicated, and for the sake of brevity, components in FIG. 8 have the same or similar arrangement and operation as those similarly numbered in system 700 shown in FIG. 7. In system 800, reactor 820 is arranged to operate in counter-current fashion. System 800 further comprises riser 830, which is in fluid communication with counter-current reactor 810 and counter-current reactor 820.

As shown, first outlet 827 of counter-current second reactor 820 is in fluid communication with riser 830, and riser 830 is in fluid communication with the second inlet 819 of counter-current first reactor 810. As shown the oxidized oxygen carriers, after undergoing regeneration, are pneumatically provided from the first outlet 827 to the second inlet 819.

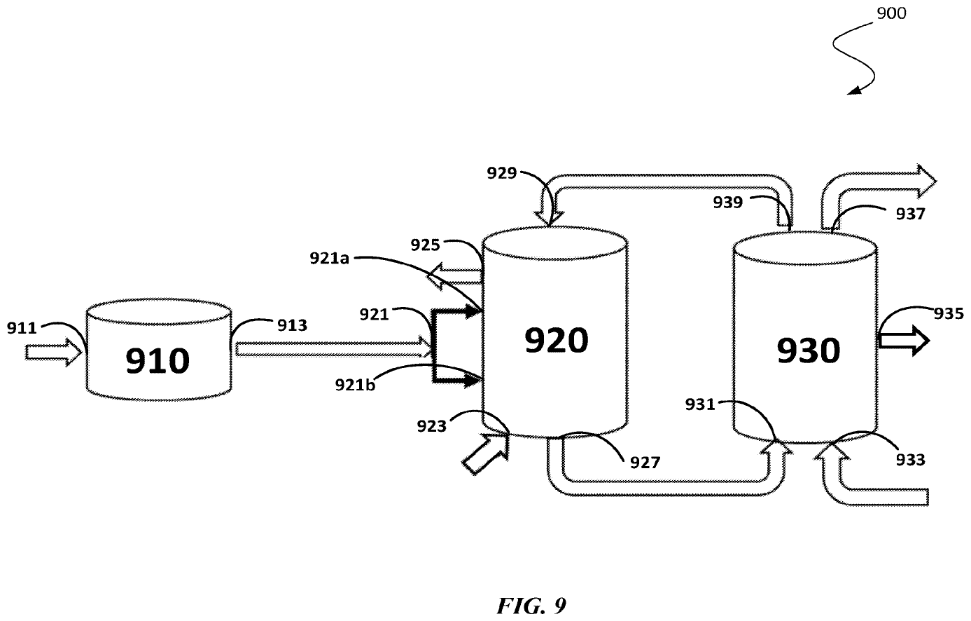

FIG. 9 shows an exemplary system 900 for processing plastic material. System 900 comprises pyrolysis reactor 910 in fluid communication with counter-current first reactor 920, and counter-current first reactor 920 is in fluid communication with co-current second reactor 930. System 900 further comprises co-current second reactor 930 in fluid communication with counter-current first reactor 920. Pyrolysis reactor includes pyrolysis inlet 911 and pyrolysis outlet 913 which is in fluid communication with counter-current first reactor 920. Counter-current first reactor 920 includes first inlet 921, second inlet 929, and third inlet 923, such that counter-current first reactor 930 is arranged to operate in counter-current flow fashion. Counter-current 920 further includes first outlet 925 and second outlet 927 which is in fluid communication with co-current second reactor 930. Co-current second reactor 930 includes first inlet 931 and second inlet 933, such that co-current second reactor 930 is arranged to operate in co-current flow fashion. Co-current second reactor 930 further includes first outlet 939 which is in fluid communication with counter-current first reactor 920, second outlet 937, and energy transfer 935.

As shown, a feedstock is fed into pyrolysis inlet 911 of pyrolysis reactor 910, where the feedstock comprises plastic material. In various implementations, pyrolysis reactor 910 operates to oxidize the feedstock into char and/or heavy volatiles. As shown, the pyrolysis outlet 913 of pyrolysis reactor 910 is in fluid communication with the first inlet 921 of counter-current first reactor 920, where a stream of char and/or heavy volatiles is provided from pyrolysis outlet 913 to the first inlet 921.

As shown, the stream of char and/or heavy volatiles is fed into the first inlet 921 at a middle portion of counter-current first reactor 920. In various implementations, where the stream of char and/or heavy volatiles are provided to the middle portion of counter-current first reactor 920 the char and/or heavy volatiles may undergo devolatilization at operating temperatures between 100° C. to 1000° C. In various implementations, the volatile components travel counter-currently in counter-current first reactor 920, and the char flows co-currently with the oxygen carriers in counter-current first reactor 920. In various implementations, providing the feedstock at the middle portion of counter-current first reactor 920 may provide full conversion of the char and/or heavy volatiles, thereby maximizing the reduction of the oxygen carriers.

As shown, the first inlet 921 of counter-current first reactor 920 comprises one or more inlets. In various implementations, the first inlet 921 includes, at least, 921a and 921b. In various implementations, one or more inlets 921a and 921b are positioned equidistantly from the top and bottom of counter-current first reactor 920, respectively. In various implementations, one or more inlets 921a and 921b are positioned within the middle one-third portion of counter-current first reactor 920. In various implementations, counter-current first reactor 920 may be configured as a moving bed reactor.

As shown, oxygen-source materials are provided to a third inlet 923 of counter-current first reactor 920. In various implementations, the oxygen-source materials comprise one or more of steam (H₂O) and/or carbon dioxide (CO₂).

In various implementations, the stream of char and/or heavy volatiles are catalytically decomposed using oxygen carriers in counter-current first reactor 920 to form completely oxidized products. The oxygen carriers in counter-current first reactor 920 crack higher hydrocarbons into completely oxidized products. As shown, the completely oxidized products are provided from the first outlet 925 of counter-current first reactor 920.

In various implementations, the oxygen carriers undergo reduction by the loss of lattice oxygen during the oxidation of the feedstock in counter-current first reactor 920. As shown, the second outlet 927 of counter-current first reactor 920, is in fluid communication with the first inlet 931 of co-current second reactor 930, where the reduced oxygen carriers are provided from the second outlet 927 to the first inlet 931. In various implementations, co-current second reactor 930 may be configured as a fluidized bed reactor.

As shown, air is provided to the second inlet 933 of the co-current second reactor 930. In various implementations, the air regenerates the reduced oxygen carriers in co-current second reactor 930.

In various implementations, the regeneration occurring in co-current second reactor 930 generates thermal energy. As shown, the thermal energy is obtained from co-current second reactor 930 by energy transfer 935. In various implementations, energy transfer 935 comprises a heat transfer fluid.

As shown, depleted air is provided from the second outlet 937 of co-current second reactor 930.

As shown, the first outlet 939 of co-current second reactor 930 is in fluid communication with the second inlet 929 of counter-current first reactor 920, where the oxidized oxygen carriers, after undergoing regeneration, are provided from the first outlet 939 to the second inlet 929.

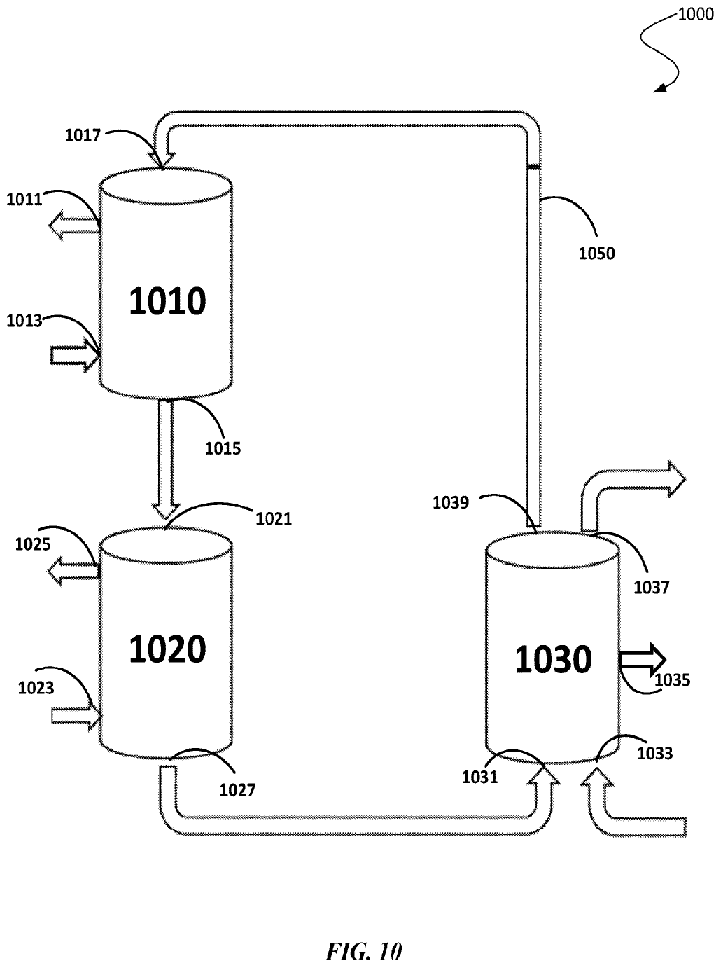

FIG. 10 shows an exemplary system 1000 for processing plastic material. Unless otherwise indicated, and for the sake of brevity, components in FIG. 10 have the same or similar arrangement and operation as those similarly numbered in system 400 shown in FIG. 4. System 1000 does not include bypass 440, which is part of system 400. System 1000 also has first reactor 1010 configured for counter-current operation, where first reactor 410 is configured for co-current operation in system 400.

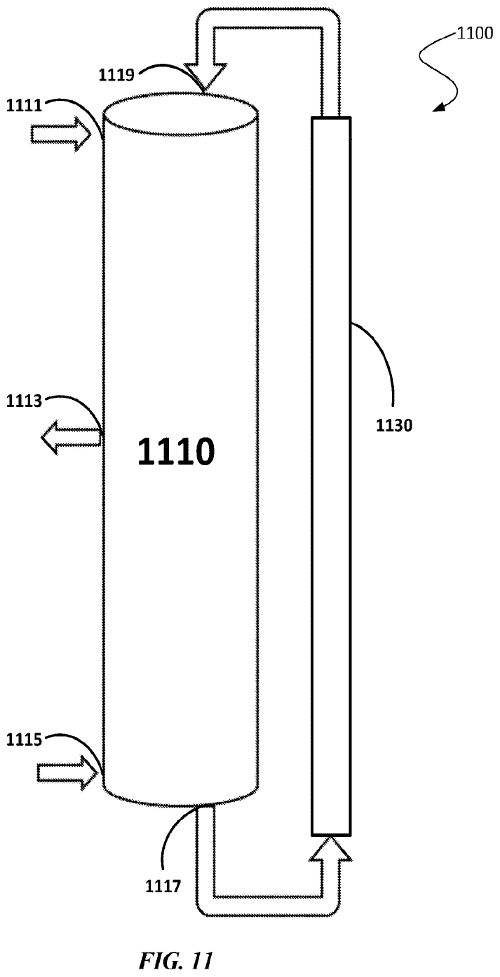

FIG. 11 shows an exemplary system 1100 for processing plastic material. System 1100 comprises cross-current reactor 1110 in fluid communication with riser 1130, and riser 1130 is in fluid communication with cross-current reactor 1110. Cross-current reactor 1110 includes first inlet 1111, second inlet 1119, and third inlet 1115, such that reactor 1110 is arranged to operate in cross-current flow fashion. Cross-current reactor 1110 further includes first outlet 1113 and second outlet 1117 which is in fluid communication with riser 1130.

As shown, a feedstock is fed into the first inlet 1111 of cross-current reactor 1110, where the feedstock comprises plastic material. In various implementations, cross-current reactor 1110 may be configured as a moving bed reactor. As shown, oxidizing materials are provided to the second inlet 1115 of cross-current reactor 1110. In various implementations, the oxidizing materials comprise one or more of steam (H₂O) and/or carbon dioxide (CO₂)

In various implementations, the feedstock is catalytically decomposed using oxygen carriers in cross-current reactor 1110 to form syngas. The oxygen carriers in cross-current reactor 1110 crack higher hydrocarbons into syngas. As shown, the syngas is provided from the first outlet 1113 of cross-current reactor 1110, where the second outlet 1113 is located at or near a middle portion of cross-current reactor 1110.

In various implementations, the oxygen carriers undergo reduction by the loss of lattice oxygen during the oxidation of the feedstock in cross-current reactor 1110.

In various implementations, the oxidizing materials regenerates the reduced oxygen carriers in cross-current reactor 1110.

As shown, the second outlet 1117 is in fluid communication with riser 1130, and riser 1130 is in fluid communication with the second inlet 1119 of cross-current reactor 1110. As shown, the oxidized oxygen carriers, after undergoing regeneration, are pneumatically provided from the second outlet 1117 to the second inlet 1119.

In various implementations, cross-current reactor 1110 combines with the reduction and oxidation reactions across the profile of the moving bed reactor, which may be accomplished due in part, to the oxidizing material decomposing into syngas products as they re-oxidize (i.e., regenerate) the oxygen carriers.

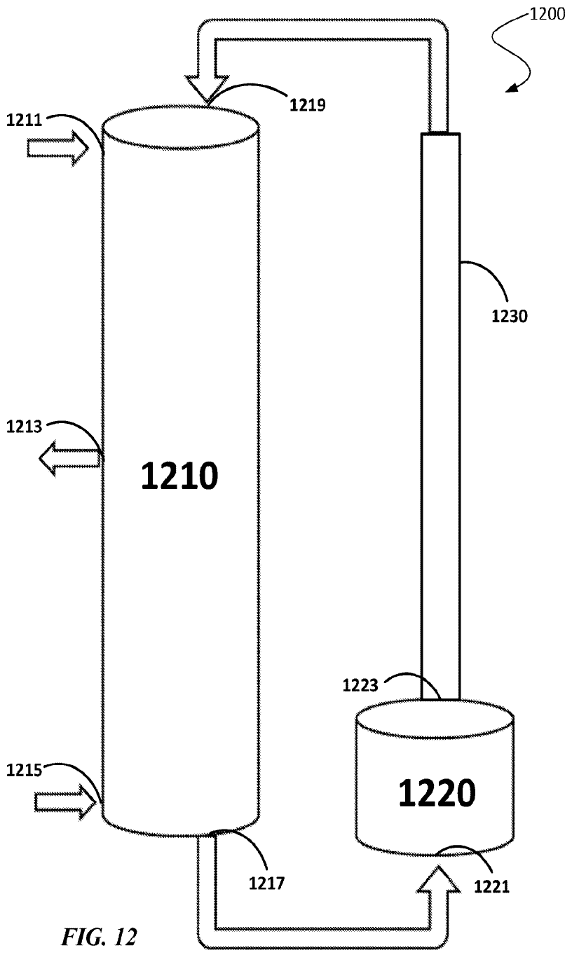

FIG. 12 shows an exemplary system 1200 for processing plastic material. Unless otherwise indicated, and for the sake of brevity, components in FIG. 12 have the same or similar arrangement and operation as those similarly numbered in system 1100 shown in FIG. 11. System 1200 additionally comprises combustor reactor 1220, which is in fluid communication with cross-current reactor 1210 and riser 1230. Combustor reactor 1220 includes combustor inlet 1221 and combustor outlet 1223. Combustor reactor 1220 may be configured to operate as a fluidized bed.

In various implementations, the oxidizing materials re-oxidizes (i.e., regenerates) the reduced oxygen carriers in cross-current reactor 1210. In various implementations, cross-current reactor 1210 does not completely re-oxidize (i.e., regenerate) the oxygen carriers.

As shown, second outlet 1217 is in fluid communication with combustor inlet 1221 of combustor reactor 1221, where a stream of completely and partially oxidized oxygen carriers are provided from the second outlet 1217 to the combustor inlet 1221. In various implementations, combustor reactor 1220 completely re-oxidizes (i.e., regenerates) all of the oxygen carriers.

As shown, combustor outlet 1223 is in fluid communication with riser 1230, and riser 1230 is in fluid communication with the second inlet 1219 of the cross-current reactor 1210. As shown, the oxidized oxygen carriers are pneumatically provided from the combustor outlet 1223 to the second inlet 1219.

In various implementations, cross-current reactor 1110 combines with the reduction and oxidation reactions across the profile of the moving bed reactor, which may be accomplished due in part, to the oxidizing material decomposing into syngas products as they re-oxidize the oxygen carriers.

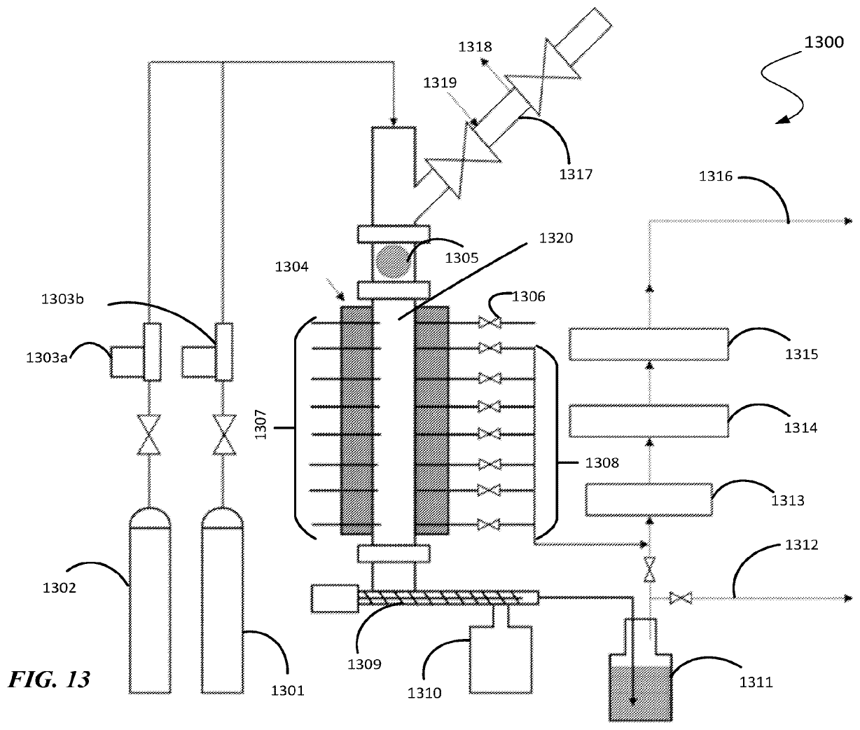

FIG. 13 shows an exemplary system 1300 for processing plastic material. System 1300 comprises a reactor body 1320 which comprises a 5.08 cm diameter column with a heated section of 76.2 cm. In various implementations, iron-titanium complex redox material (ITCMO) particles of the 1000-1500 μm mesh size are utilized as an exemplary material to perform the thermal degradation of the plastics. In various implementations, polyethylene beads of 1-1.5 mm diameter mesh size is fed to moving bed bench scale reactor system 1300 as an exemplary plastic feed. In various implementations, the redox particles and the exemplary plastics are mixed together and fed to a moving bed reactor.

As shown, system 1300 comprises inlet port 1317, reactor body 1320, furnace 1304, screw feeder 1309 and bottom particle isolation chamber 1310. As shown, the exemplary feed enters the reactor through the inlet port 1317 which comprises a lock hopper and moves downwards into the heated section of the reactor body 1320. As shown, gases are expelled from inlet port 1317 through vent 1318. As shown, nitrogen gas (N₂) is provided to the inlet port 1317 through inlet 1319. As shown, nitrogen gas (N₂) 1302 is provided to the top of moving bed bench scale reactor system 1300, and the flow is controlled by mass flow controller 1303a. As shown, carbon dioxide (CO₂) is provided to the top of moving bed bench scale reactor 1300, and the flow is controlled by mass flow controller 1303b.

As shown, the furnace 1304 heats the reactor body 1320 to a desired temperature and the temperature may be monitored using thermocouples 1307 at various points along the shaft of the reactor body 1320. As shown, water is fed into the reactor by port 1306. As shown, the screw feeder 1309 at the bottom of the reactor pushes the reactor solids into the particle isolation chamber 1310 and thus the solids from the reactor keep moving as a packed moving bed reactor. As shown, the gas inlet and outlet ports 1308 across the reactor help in sampling the gases. As shown, the outlet gases are cooled and passed through a desiccant 1314 and the outlet gases are provided to an IR analyzer 1315, and then the outlet gases are provided to an H₂ analyzer 1315. In various implementations, the gas analyzers 1314 and 1315 are used in the experiment are SEIMENS CALOMAT and SEIMENS ULTRAMAT analyzer that work on the principle of infra-red gas detection techniques.

As shown, vents 1316 and 1312 vent out gases, respectively. As shown, water trap 1311 collects excess moisture, steam, and/or water from system 1300.

### V. Exemplary Methods of Operation

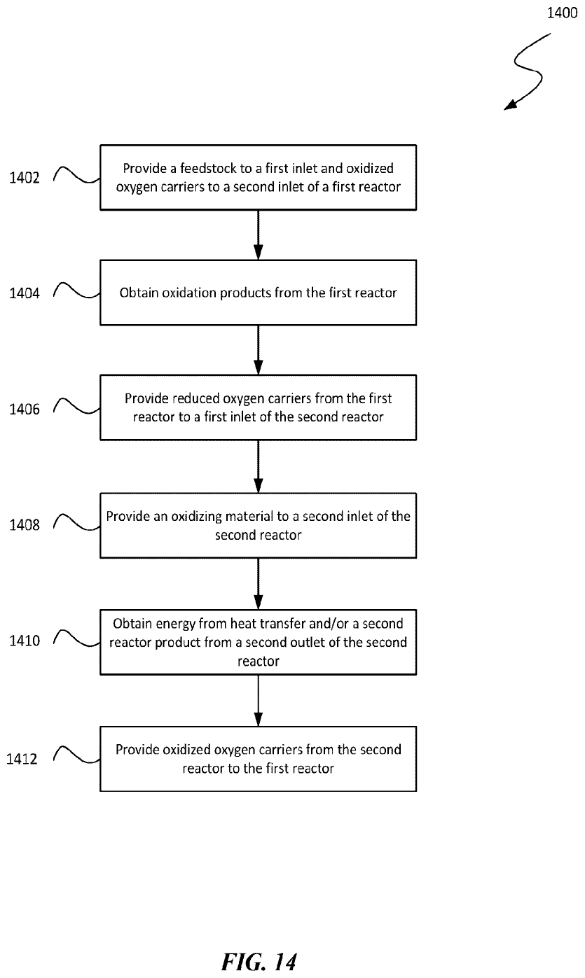

Exemplary methods of processing plastic materials may comprise various operations. FIG. 14 shows example method 1400 for processing plastic materials. As shown, method 1400 includes providing a feedstock to a first inlet and oxidized oxygen carriers to a second inlet of a first reactor (operation 1402), obtaining oxidation products from the first reactor (operation 1404), providing reduced oxygen carriers from the first reactor to a first inlet of the second reactor (operation 1406), providing an oxidizing material to a second inlet of the second reactor (operation 1408), obtaining energy and/or a second reactor product from the second reactor (operation 1410), and providing oxidized oxygen carriers from the second reactor to the first reactor. Other embodiments may include more or fewer operations. Exemplary systems described and contemplated herein can be utilized to perform the operations of method 1400.

Operating conditions during method 1400 may vary based on the thermodynamic and kinetic properties of the oxygen carriers and the feedstock. In various implementations, elevated temperatures require that the system comprise a refractory lined vessel, to maintain the temperature within the reactor, and also maintain the structural integrity of the exterior cladding. In various implementations, the exterior of the system may be maintained at low temperatures, thereby allowing the pressure of the system to operate up to 15 MPa.

In some instances, method 1400 may begin by providing a feedstock to a pyrolysis reactor. As discussed above with reference to, at least, FIG. 9, the pyrolysis reactor may operate to generate char and/or heavy volatiles from the feedstock.

In various implementations, the pyrolysis reactor may be operated at a temperature of about 200° C. to 1000° C.; 335° C. to 1000° C.; 250° C. to 1000° C.; 275° C. to 1000° C.; 300° C. to 1000° C.; 325° C. to 1000° C.; 350° C. to 1000° C.; 400° C. to 1000° C.; 500° C. to 1000° C.; 550° C. to 1000° C.; 600° C. to 1000° C.; 650° C. to 1000° C.; 700° C. to 1000° C.; 800° C. to 1000° C.; 900° C. to 1000° C.; or 950° C. to 1000° C. In various implementations, the pyrolysis reactor may be operated at a temperature no less than 200° C.; no less than 250° C.; no less than 300° C.; no less than 350° C.; no less than 400° C.; no less than 450° C.; no less than 500° C.; no less than 550° C.; no less than 600° C.; no less than 650 C; no less than 700° C.; no less than 750° C.; no less than 800° C.; no less than 850° C.; no less than 900° C.; or no less than 950° C. In various implementations, the pyrolysis reactor may be operated at a temperature of no greater than 1000° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; or no greater than 225° C.

In various implementations, the pyrolysis reactor may be operated at a pressure of about 0.1 MPa to 5 MPa; 0.5 MPa to 5 MPa; 1 MPa to 5 MPa; 1.5 MPa to 5 MPa; 2 MPa to 5 MPa; 2.5 MPa to 5 MPa; 3 MPa to 5 MPa; 3.5 MPa to 5 MPa; or 4 MPa to 5 MPa. In various implementations, the pyrolysis reactor may be operated at a pressure of no less than 0.1 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 1.5 MPa; no less than 2 MPa; no less than 2.5 MPa; no less than 3 MPa; no less than 3.5 MPa; no less than 4 MPa; or no less than 4.5 MPa. In various implementations, the pyrolysis reactor may be operated at a pressure of no greater than 5 MPa; no greater than 4.75 MPa; no greater than 4.25 MPa; no greater than 3.75 MPa; no greater than 3.25 MPa; no greater than 2.75 MPa; no greater than 2.25 MPa; no greater than 1.75 MPa; no greater than 1.25 MPa; no greater than 1 MPa; no greater than 0.85 MPa; no greater than 0.75 MPa; no greater than 0.65 MPa; no greater than 0.55 MPa; no greater than 0.45 MPa; no greater than 0.35 MPa; no greater than 0.25 MPa; or no greater than 0.15 MPa.

Method 1400 may also begin by providing a feedstock to a first inlet and oxidized oxygen carriers to a second inlet of a first reactor (operation 1402). Exemplary feedstock and oxygen carriers are described in greater detail above.

In various implementations, oxygen carriers and feedstock may be provided as a weight ratio of active material to feedstock between 4:1 and 10:1; between 4:1 and 7:1; between 7:1 and 10:1; between 4:1 and 6:1; between 6:1 and 8:1; between 8:1 and 10:1; between 5:1 and 7:1; or between 7:1 and 9:1. In various implementations, the oxygen carriers and feedstock are provided at a weight ratio of active material to feedstock no less than 4:1; no less than 5:1; no less than 6:1; no less than 7:1; no less than 8:1; no less than 9:1; or no less than 10:1. In various implementations, the oxygen carriers and feedstock are provided at a weight ratio of active material to feedstock no greater than 10:1; no greater than 9:1; no greater than 8:1; no greater than 7:1; no greater than 6:1; no greater than 5:1; or no greater than 4:1.

In various implementations, the weight ratio of the active material to support material of the oxygen carriers is 1:1. In some implementations, the proportion of the active component in the oxygen carrier may vary, and the weight ratio of the oxygen carrier to the feedstock may change accordingly, although the weight ratio of active material to feedstock is between 4:1 and 10:1.

Exemplary systems and methods may include a feedstock that is screw fed, vibratory tray fed, conveyed pneumatically, or conveyed through a rotary feeder, all of which are able to accomplish steady mass flow. Exemplary systems and methods may utilize these feeders, such that they maintain a pressure above and/or distance away from the injection point on exemplary reactor systems so that premature degradation does not occur. This provides solutions to operability problems when feeding the plastics into the exemplary systems. In some implementations, the plastics will be fed at an angle greater than or equal to 60° to prevent fouling of the injection line.

Exemplary systems and methods may include molten feeding, the plastic may be injected as close to the reactor as possible, maintaining plug flow through the feeder. Feeding molten plastic favors the use of a screw feeder, which operates to lower and/or prevent fouling of the injection as the flighting wipes the walls of the injection housing. In some implementations, molten feeding may include increased temperature control to prevent pyrolysis form occurring in the feeder.

In some instances, method 1400 may include removing, using a third reactor, at least one of chlorine (Cl⁻) ions, bromine (Br⁻) ions, or fluorine (F⁻) ions from the feedstock. Removing one or more of these target species generates a dehalogenated stream. The dehalogenated stream may then be provided to the first reactor.

Referring again to FIG. 14, the first reactor operates to oxidize the feedstock to partial oxidation products or complete oxidation products (operation 1404). Exemplary oxidation products may comprise carbon monoxide (CO), hydrogen gas (H₂), carbon dioxide (CO₂), and combinations thereof.

In various implementations, the first reactor may be operated at a temperature of about 300° C. to about 1500° C.; 350° C. to 1500° C.; 400° C. to 1500° C.; 450° C. to 1500° C.; 450° C. to 1400° C.; 450° C. to 1300° C.; 500° C. to 1300° C.; 550° C. to 1300° C.; 550° C. to 1250° C.; 600° C. to 1250° C.; 500° C. to 1200° C.; 650° C. to 1200° C.; 650° C. to 1150° C.; or 700° C. to 1100° C. In various implementations, the first reactor may be operated at a temperature of no less than 300° C.; no less than 350° C.; no less than 400° C.; no less than 450° C.; no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; no less than 1150° C.; no less than 1200° C.; no less than 1250° C.; no less than 1300° C.; no less than 1350° C.; no less than 1400° C.; or no less than 1450° C. In various implementations, the first reactor may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; or no greater than 325° C.

In various implementations, the first reactor may be operated at a pressure of about 0.1 MPa to about 15 MPa; 0.1 MPa to 14 MPa; 0.1 to 13 MPa; 0.1 to 12 MPa; 0.1 MPa to 11 MPa; 0.1 MPa to 10 MPa; 0.1 MPa to 9 MPa; 0.1 MPa to 8 MPa; 0.1 MPa to 7 MPa; 0.1 MPa to 6 MPa; 0.1 MPa to 5 MPa; 0.1 MPa to 4 MPa; 0.1 MPa to 3 MPa; 0.1 MPa to 2 MPa; 0.1 MPa to 1 MPa; 0.1 MPa to 0.5 MPa; 1 MPa to 15 MPa; 2 MPa to 15 MPa; 3 MPa to 15 MPa; 4 MPa to 15 MPa; 5 MPa to 15 MPa; 10 MPa to 15 MPa; 11 MPa to 15 MPa; 12 MPa to 15 MPa; 13 MPa to 15 MPa; or 14 MPa to 15 MPa. In various implementations, the first reactor may be operated at a pressure of no less than 0.1 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 5 MPa; no less than 8 MPa; no less than 10 MPa; no less than 12 MPa; or no less than 14 MPa. In various implementations the first reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 7 MPa; no greater than 6 MPa; no greater than 4 MPa; no greater than 3 MPa; no greater than 1 MPa; no greater than 0.8 MPa; or no greater than 0.5 MPa.

Reduced oxygen carriers are provided from the first reactor to the second reactor (operation 1406). The first reactor is in fluid communication with the second reactor. A stream of oxidizing material is also provided to the second reactor (operation 1408). The second reactor operates to oxidize (i.e., regenerate) the reduced oxygen carriers to generate oxidized oxygen carriers.

In various implementations, the second reactor may be operated at a temperature between about 300° C. to 1500° C.; 350° C. to 1500° C.; 400° C. to 1500° C.; 450° C. to 1500° C.; 450° C. to 1400° C.; 450° C. to 1300° C.; 500° C. to 1300° C.; 550° C. to 1300° C.; 550° C. to 1250° C.; 600° C. to 1250° C.; 600° C. to 1200° C.; 650° C. to 1200° C.; 650° C. to 1150° C.; or 750° C. to 1150° C. In various implementations, the second reactor may be operated at a temperature of no less than 300° C.; no less than 350° C.; no less than 400° C.; no less than 450° C.; no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; no less than 1150° C.; no less than 1200° C.; no less than 1250° C.; no less than 1300° C.; no less than 1350° C.; no less than 1400° C.; or no less than 1450° C. In various implementations, the second reactor may be operated at a temperature of no greater than 1500° C.; no greater than 1475° C.; no greater than 1425° C.; no greater than 1375° C.; no greater than 1325° C.; no greater than 1275° C.; no greater than 1225° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; or no greater than 325° C.

In various implementations, the second reactor may be operated at a pressure between 0.1 MPa to 15 MPa; 0.1 MPa to 14 MPa; 0.1 MPa to 13 MPa; 0.1 MPa to 12 MPa; 0.1 MPa to 11 MPa; 0.1 MPa to 10 MPa; 0.1 MPa to 9 MPa; 0.1 MPa to 8 MPa; 0.1 MPa to 7 MPa; 0.1 MPa to 6 MPa; 0.1 MPa to 5 MPa; 0.1 MPa to 4 MPa; 0.1 MPa to 3 MPa; 0.1 MPa to 2 MPa; 0.1 MPa to 1 MPa; 0.1 MPa to 0.5 MPa; 1 MPa to 15 MPa; 2 MPa to 15 MPa; 3 MPa to 15 MPa; 4 MPa to 15 MPa; 5 MPa to 15 MPa; 10 MPa to 15 MPa; 11 MPa to 15 MPa; 12 MPa to 15 MPa; 13 MPa to 15 MPa; or 14 MPa to 15 MPa. In various implementations, the second reactor may be operated at a pressure of no less than 0.1 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 5 MPa; no less than 8 MPa; no less than 10 MPa; no less than 12 MPa; or no less than 14 MPa. In various implementations the second reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 7 MPa; no greater than 6 MPa; no greater than 4 MPa; no greater than 3 MPa; no greater than 1 MPa; no greater than 0.8 MPa; or no greater than 0.5 MPa.

A second reactor product is obtained from the second reactor (operation 1410). Exemplary second reactor product streams may comprise depleted air, H₂, unreacted steam, carbon monoxide (CO), unreacted carbon dioxide (CO₂) and combinations thereof. In some instances, energy may also be obtained from the second reactor.

Exemplary methods may obtain energy by heat transfer from the second reactor. In various implementations, energy is obtained by combination of exemplary internal and external heat transfer mechanisms. Exemplary internal heat transfer mechanism may include jacketing the walls of the second reactor with a heat transfer media, or through an internal heat transfer coil, wherein the heat transfer media passes through the coil and performs heat transfer with the second reactor exemplary reactants and products. Exemplary external heat transfer mechanism may include heat transfer across the inlets and/or the outlets of the second reactor. The second reactor may be operated to perform heat integration across the exemplary system or throughout a chemical and/or physical plant.

The oxidized oxygen carriers are provided from the second reactor to the first reactor (operation 1412). The second reactor is in fluid communication with the first reactor.

As described above, the oxidized oxygen carriers are provided to the first reactor in a predetermined weight ratio of active material to feedstock.

Alternatively, in various implementations, method 1400 may include providing the reduced oxygen carriers from the first reactor to an oxidizer reactor which is in fluid communication between the first reactor and the second reactor. The oxidizer reactor may be operated to generate hydrogen gas (H₂).

In various implementations, the oxidizer reactor may be operated at a temperature between 500° C. to 1200° C.; 550° C. to 1200° C.; 600° C. to 1200° C.; 650° C. to 1200° C.; 650° C. to 1150° C.; 650° C. to 1100° C.; 700° C. to 1100° C.; 700° C. to 1050° C.; 700° C. to 1000° C.; 750° C. to 1000° C.; 750° C. to 950° C.; 800° C. to 950° C.; or 850° C. to 950° C. In various implementations, the oxidizer reactor may be operated at a temperature of no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; or no less than 1150° C. In various implementations, the oxidizer reactor may be operated at a temperature of no greater than 1200° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; or no greater than 525° C.

In various implementations, the oxidizer reactor may be operated at a pressure between 0.1 MPa to 15 MPa; 0.2 MPa to 15 MPa; 0.3 MPa to 15 MPa; 0.4 MPa to 15 MPa; 0.5 MPa to 15 MPa; 0.6 MPa to 15 MPa; 0.7 MPa to 15 MPa; 0.8 MPa to 15 MPa; 0.9 MPa to 15 MPa; 1 MPa to 15 MPa; 1 MPa to 14 MPa; 1 MPa to 13 MPa; 1 MPa to 12 MPa; 1 MPa to 11 MPa; 1 MPa to 10 MPa; 1 MPa to 9 MPa; 1 MPa to 8 MPa; 1 MPa to 7 MPa; 1 MPa to 6 MPa; 1 MPa to 5 MPa; 2 MPa to 15 MPa; 3 MPa to 15 MPa; 4 MPa to 15 MPa; 5 MPa to 15 MPa; 6 MPa to 15 MPa; 7 MPa to 15 MPa; 8 MPa to 15 MPa; 9 MPa to 15 MPa; or 10 MPa to 15 MPa. In various implementations, the oxidizer reactor may be operated at a pressure of no less than 0.1 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 3 MPa; no less than 4 MPa; no less than 5 MPa; no less than 8 MPa; no less than 10 MPa; no less than 12 MPa; or no less than 14 MPa. In various implementations, the oxidizer reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 8 MPa; no greater than 7 MPa; no greater than 6 MPa; no greater than 5 MPa; no greater than 4 MPa; no greater than 3 MPa; no greater than 2 MPa; no greater than 1 MPa; no greater than 0.9 MPa; no greater than 0.8 MPa; no greater than 0.7 MPa; no greater than 0.6 MPa; no greater than 0.5 MPa; no greater than 0.4 MPa; no greater than 0.3 MPa; or no greater than 0.2 MPa.

Alternatively, in various implementations, method 1400 may provide the reduced oxygen carriers from the first reactor to the second reactor by utilizing a bypass stream around an oxidizer reactor. In various implementations, the reduced oxygen carriers are provided at a predetermined percentage between 0% to 100%; 10% to 100%; 10% to 90%; 10% to 80%; 20% to 80%; 20%; to 70%; 30% to 70%; 30% to 60%; 40% to 60%; or about 50%.

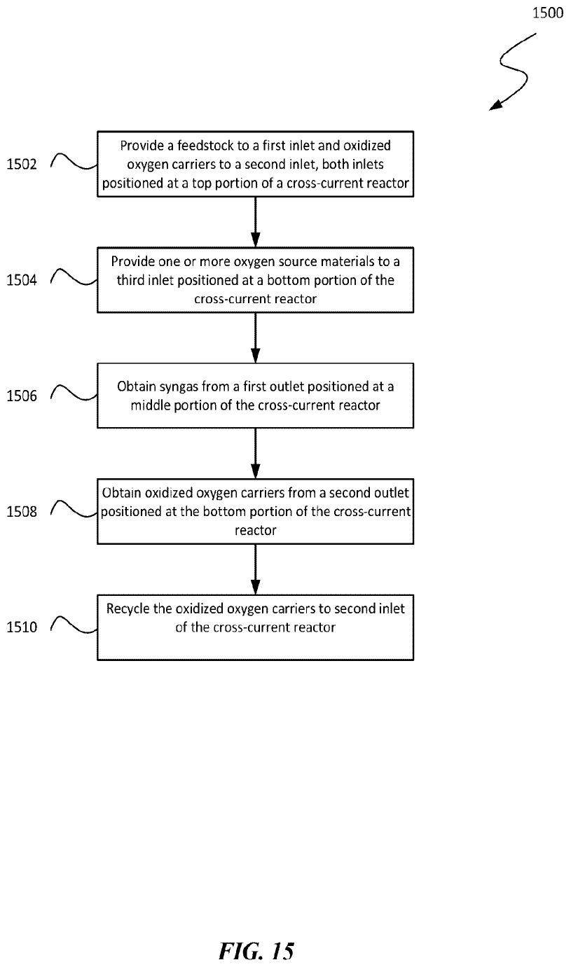

Exemplary methods of processing plastic materials may comprise various other operations. FIG. 15 shows example method 1500 for processing plastic materials. As shown, method 1500 includes providing a feedstock to a first inlet and oxidized oxygen carriers to a second inlet of a cross-current reactor (operation 1502); providing one or more oxygen source materials to a third inlet positioned at a bottom portion of the cross-current reactor (operation 1504); obtaining syngas from a first outlet positioned at a middle portion of the cross-current reactor (operation 1506); obtaining oxidized oxygen carriers from a second outlet positioned at the bottom portion of the cross-current reactor (operation 1508), and recycling the oxidized oxygen carriers to the second inlet positioned at the top portion of the cross-current reactor (operation 1510). Exemplary systems described and contemplated herein can be utilized to perform the operations of method 1500.

Method 1500 may begin by providing a feedstock to a first inlet of a cross-current reactor and oxidized oxygen carriers to a second inlet of the cross-current reactor (operation 1502). In various implementations, oxygen carriers and feedstock may be provided as a weight ratio of active material to feedstock between 4:1 and 10:1; between 4:1 and 7:1; between 7:1 and 10:1; between 4:1 and 6:1; between 6:1 and 8:1; between 8:1 and 10:1; between 5:1 and 7:1; or between 7:1 and 9:1. In various implementations, the oxygen carriers and feedstock are provided at a weight ratio of active material to feedstock no less than 4:1; no less than 5:1; no less than 6:1; no less than 7:1; no less than 8:1; no less than 9:1; or no less than 10:1. In various implementations, the oxygen carriers and feedstock are provided at a weight ratio of active material to feedstock no greater than 10:1; no greater than 9:1; no greater than 8:1; no greater than 7:1; no greater than 6:1; no greater than 5:1; or no greater than 4:1.

In various implementations, the weight ratio of the active material to support material of the oxygen carriers is 1:1. In some implementations, the proportion of the active component in the oxygen carrier may vary, and the weight ratio of the oxygen carrier to the feedstock may change accordingly, although the weight ratio of active material to feedstock is between 4:1 and 10:1.

One or more oxygen source materials may be provided to a third inlet positioned at a bottom portion of the cross-current reactor (operation 1504).

Syngas may be obtained from a first outlet positioned at a middle portion of the cross-current reactor (operation 1506). The cross-current reactor may operate to combine the reduction and oxidation reactions across the profile of the cross-current reactor, which may be accomplished due in part, to the oxidizing material decomposing into syngas products as they re-oxidize the oxygen carriers.

In various implementations, the cross-current reactor may be operated at a temperature between 500° C. to 1200° C.; 550° C. to 1200° C.; 600° C. to 1200° C.; 650° C. to 1200° C.; 650° C. to 1150° C.; 650° C. to 1100° C.; 700° C. to 1100° C.; 700° C. to 1050° C.; 700° C. to 1000° C.; 750° C. to 1000° C.; 750° C. to 950° C.; 800° C. to 950° C.; 850° C. to 950° C.; or about 750° C. to 1150° C. In various implementations, the cross-current reactor may be operated at a temperature of no less than 500° C.; no less than 550° C.; no less than 600° C.; no less than 650° C.; no less than 700° C.; no less than 750° C.; no less than 800° C.; no less than 850° C.; no less than 900° C.; no less than 950° C.; no less than 1000° C.; no less than 1050° C.; no less than 1100° C.; or no less than 1150° C. In various implementations, the cross-current reactor may be operated at a temperature of no greater than 1200° C.; no greater than 1175° C.; no greater than 1125° C.; no greater than 1075° C.; no greater than 1025° C.; no greater than 975° C.; no greater than 925° C.; no greater than 875° C.; no greater than 825° C.; no greater than 775° C.; no greater than 725° C.; no greater than 675° C.; no greater than 625° C.; no greater than 575° C.; or no greater than 525° C.

In various implementations, the cross-current reactor may be operated at a pressure between 0.1 MPa to 15 MPa; 0.2 MPa to 15 MPa; 0.3 MPa to 15 MPa; 0.4 MPa to 15 MPa; 0.5 MPa to 15 MPa; 0.6 MPa to 15 MPa; 0.7 MPa to 15 MPa; 0.8 MPa to 15 MPa; 0.9 MPa to 15 MPa; 1 MPa to 15 MPa; 1 MPa to 14 MPa; 1 MPa to 13 MPa; 1 MPa to 12 MPa; 1 MPa to 11 MPa; 1 MPa to 10 MPa; 1 MPa to 9 MPa; 1 MPa to 8 MPa; 1 MPa to 7 MPa; 1 MPa to 6 MPa; 1 MPa to 5 MPa; 2 MPa to 15 MPa; 3 MPa to 15 MPa; 4 MPa to 15 MPa; 5 MPa to 15 MPa; 6 MPa to 15 MPa; 7 MPa to 15 MPa; 8 MPa to 15 MPa; 9 MPa to 15 MPa; 10 MPa to 15 MPa, or about 0.1 MPa to 5 MPa. In various implementations, the cross-current reactor may be operated at a pressure of no less than 0.1 MPa; no less than 0.2 MPa; no less than 0.3 MPa; no less than 0.4 MPa; no less than 0.5 MPa; no less than 0.6 MPa; no less than 0.7 MPa; no less than 0.8 MPa; no less than 0.9 MPa; no less than 1 MPa; no less than 2 MPa; no less than 3 MPa; no less than 4 MPa; no less than 5 MPa; no less than 8 MPa; no less than 10 MPa; no less than 12 MPa; or no less than 14 MPa. In various implementations, the cross-current reactor may be operated at a pressure of no greater than 15 MPa; no greater than 14 MPa; no greater than 13 MPa; no greater than 12 MPa; no greater than 11 MPa; no greater than 10 MPa; no greater than 9 MPa; no greater than 8 MPa; no greater than 7 MPa; no greater than 6 MPa; no greater than 5 MPa; no greater than 4 MPa; no greater than 3 MPa; no greater than 2 MPa; no greater than 1 MPa; no greater than 0.9 MPa; no greater than 0.8 MPa; no greater than 0.7 MPa; no greater than 0.6 MPa; no greater than 0.5 MPa; no greater than 0.4 MPa; no greater than 0.3 MPa; or no greater than 0.2 MPa.

The oxidized oxygen carriers are obtained from a second outlet from the bottom of the cross-current reactor (operation 1508).

The oxidized oxygen carriers may be recycled from the bottom outlet of the cross-current reactor to the top inlet of the cross-current reactor at a ratio as described above (operation 1510).

Alternatively, in various implementations, method 1500 may provide both oxidized and partially oxidized oxygen carriers from the bottom outlet of the cross-current reactor to a combustor reactor. The combustor reactor may operate to completely oxidize the oxygen carriers provided from the cross-current reactor. Then the oxidized oxygen carriers may be provided to the second inlet of the cross-current reactor.

### VI. Experimental Data

Experiments have been conducted in the reactor system 1300 to test the feasibility of the redox plastic treatment system. An iron-titanium complex redox material (ITCMO) particle of the 1000-1500 μm mesh size has been used as an exemplary material to perform the thermal degradation of the plastics. The experiment used polyethylene beads of 1-1.5 mm diameter mesh size as an exemplary plastic feed. The redox particles and the exemplary plastics were mixed together and fed to a moving bed reactor as shown in the FIG. 13.

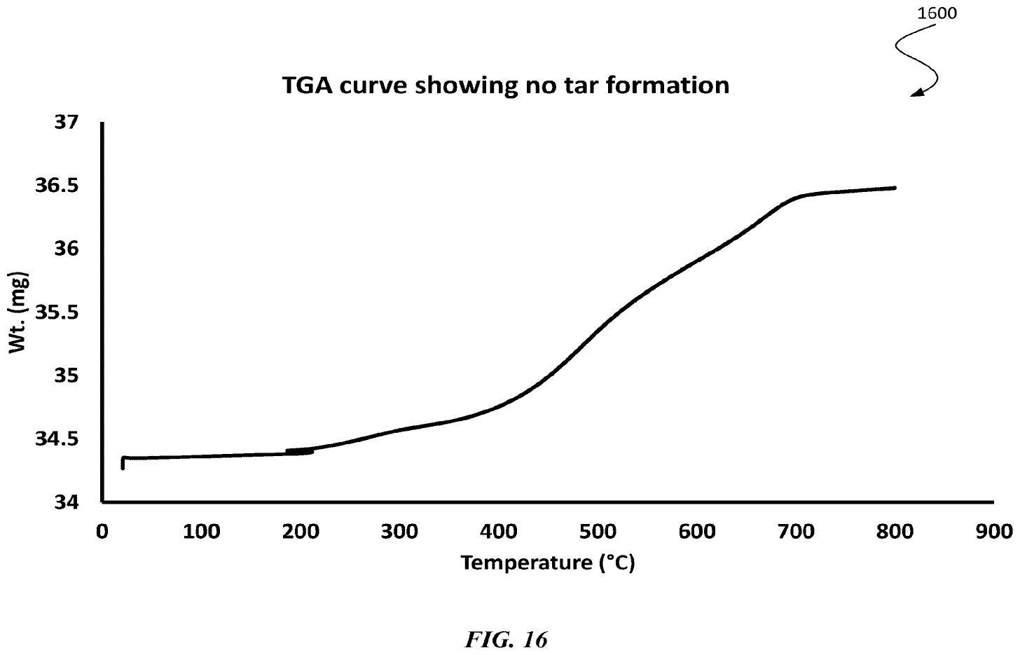

The results for the experiment conducted at 1 atm pressure and 1000° C. temperature are shown in FIG. 16. Redox solids and plastics were mixed in a predetermined weight ratio of 15.1 and injected into the moving bed reactor. Exemplary redox solids comprised 50 wt. % active material, thus the weight ratio of active material to plastics was 7.5:1.

A steam flowrate of 1.8 ml/min. at 1 atm and 120° C. was co-injected into the system as a gasification agent and to increase the syngas quality. 1 SLPM of N₂ was passed through the reactor as a carrier gas.

As observed from the results, the plastics volatilize as they enter into the reactor and react with the ITCMO particles and establish a gas profile in the moving bed. The volatiles extract the lattice oxygen from the ITCMO particles and reduce them to lower oxidation states while oxidizing to H₂ and CO. The active sites on the ITCMO particles also act as sites for cracking the tars formed during the volatilization of plastics. Since the redox solids have excess lattice oxygen initially, the full oxidation products are favored and the full oxidation product CO₂ were observed at the reactor outlet. As the solids move down the reactor and establish a steady state profile with the gases, the CO₂ concentration decreases and syngas purity (H₂+CO) increases. The gases equilibrate with the solids while travelling through the reactor and a steady gas profile was observed at the reactor outlet.

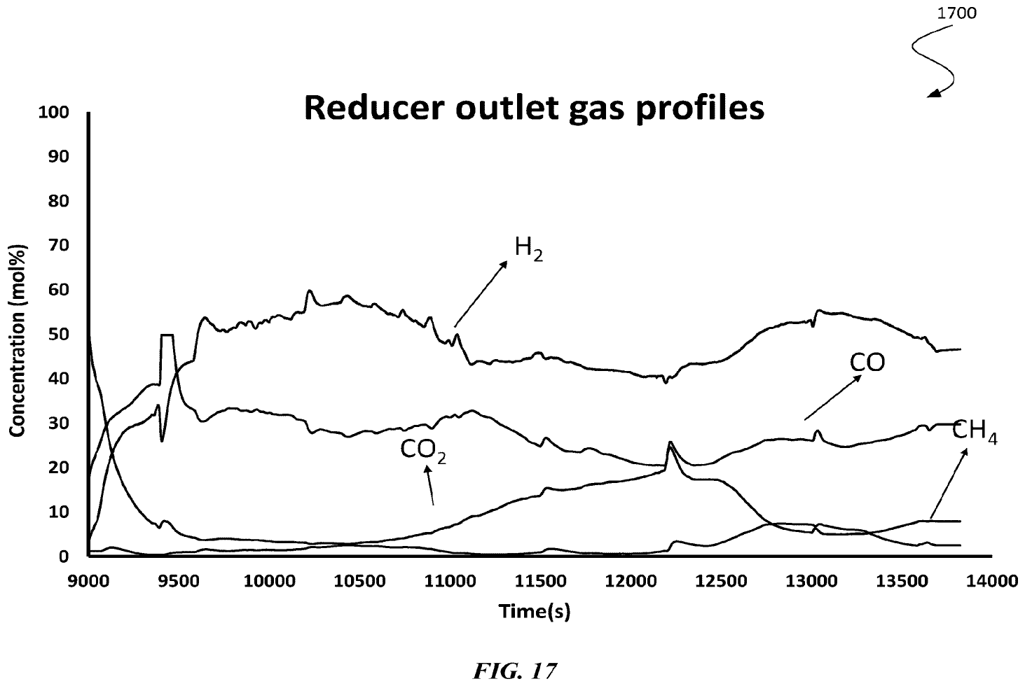

To check the redox particles for any traces of tar, the reduced particles from the bottom of the reactor are tested in a thermogravimetric analyzer. FIG. 17 shows the temperature programmed oxidation curve for the sample particles. The ramp rate used for the experiment was 2° C./min for ramping the temperature from 200° C. to 800° C. A gas mixture containing air (50%) and nitrogen (50%) is used to create oxidizing atmosphere in the TGA during the temperature ramp.

As was observed from the TGA curve as shown in FIG. 17, as the temperature of the system rises, the weight of the sample particles also increases. The increase in the weight is attributed to two factors: (1) decrease in the buoyancy of the surrounding gases leading to an increase in the weight, and (2) the oxidation of the particles leads to an increase in the weight. As was observed for the sample particles, there is a change in the slope of the curve around 400° C., suggesting that the particles start to oxidize around 400° C. In case of any carbon deposition from tars on the particles, the weight of the sample would decrease at certain temperature where the carbon starts to react with oxygen in the air and burn off. However, it may be concluded that from the temperature programmed oxidation curve that there is no decrease in the weight of the sample at any point of the experiment. It may be concluded that no tar has been deposited on the particles and the tar cracking efficiency of moving bed system is close to 100%.

For reasons of completeness, the following Embodiments are provided:

Embodiment 1. A method for processing plastic material, the method comprising:
providing a feedstock to a first inlet of a first reactor, the feedstock comprising plastic material;
providing oxidized oxygen carriers to a second inlet of the first reactor, the oxidized oxygen carriers comprising active material and being provided such that a weight ratio of active material to feedstock is no less than 4:1 and no greater than 10:1;
obtaining oxidation products from a first outlet of the first reactor;
providing reduced oxygen carriers from a second outlet of the first reactor to a first inlet of the second reactor;
providing an oxidizing material to a second inlet of the second reactor; and
obtaining energy and/or a second reactor product stream from the second reactor.

Embodiment 2. The method according to Embodiment 1, the method further comprising:
transporting, using a riser, the oxidized oxygen carriers to the second inlet of the first reactor from a first outlet of the second reactor.

Embodiment 3. The method according to Embodiment 1 or Embodiment 2, further comprising providing the feedstock to an inlet of a pyrolysis reactor in fluid communication with the first inlet of the first reactor;
generating char or heavy volatiles using the pyrolysis reactor; and
providing the char or heavy volatiles from an outlet of the pyrolysis reactor to the first inlet of the first reactor.

Embodiment 4. The method according to any one of Embodiments 1-3, wherein the oxidized oxygen carriers comprise 50% by weight active material; and
wherein the weight ratio of active material to the feedstock is no less than 5:1 and no greater than 9:1.

Embodiment 5. The method according to any one of Embodiments 1-4, the feedstock and the oxidized oxygen carriers being provided to the first reactor as co-current streams.

Embodiment 6. The method according to any one of Embodiments 1-5, further comprising an oxidizer reactor in fluid communication with the first reactor and the second reactor;
providing the reduced oxygen carriers to a first inlet of the oxidizer reactor from the second outlet of the first reactor;
providing steam (H₂O) to a second inlet of the oxidizer reactor;
generating hydrogen gas (H₂) in the oxidizer reactor; and
providing partially reduced oxygen carriers to the first inlet of the second reactor.

Embodiment 7. The method according to Embodiment 6, further comprising a bypass stream, the bypass stream directing at least 10% of the reduced oxygen carriers from the first reactor to the second reactor.

Embodiment 8. The method according to any one of Embodiments 1-7, the first reactor operating at a temperature between 300° C. to 1500° C.; and
the first reactor operating at a pressure between 0.1 MPa to 15 MPa.

Embodiment 9. The method according to any one of Embodiments 1-8, the second reactor operating at a temperature between 300° C. to 1500° C.; and
the second reactor operating at a pressure between 0.1 MPa to 15 MPa.

Embodiment 10. The method according to any one of Embodiments 1-9, the feedstock further comprising char or heavy volatiles.

Embodiment 11. The method according to any one of Embodiments 1-10, the oxidizing material comprising carbon dioxide (CO₂), steam (H₂O), air, oxygen (O₂), or combinations thereof, and
the second reactor product stream comprising carbon monoxide (CO), hydrogen gas (H₂) and/or syngas.

Embodiment 12. The method according to any one of Embodiments 1-11, further comprising:
removing, using a third reactor, at least one of chlorine (Cl⁻) ions, bromine (Br⁻) ions, or fluorine (F⁻) ions from the feedstock, thereby generating a dehalogenated stream, the first reactor being in fluid communication with the third reactor; and
providing the dehalogenated stream to the first inlet of the first reactor.

Embodiment 13. The method according to any one of Embodiments 1-12, wherein the second reactor product stream has a maximum tar content of no greater than 50 g/Nm³.

Embodiment 14. The method according to any one of Embodiments 1-13, the method further comprising:
providing one or more oxygen-source materials to a third inlet of the first reactor,
the one or more oxygen source materials comprising steam (H₂O) and/or carbon dioxide (CO₂).

Embodiment 15. The method according to any one of Embodiments 1-14, the method further comprising:
collecting an output stream comprising the oxidized oxygen carriers from a third outlet of the second reactor; and
providing the collected oxidized oxygen carriers to the second inlet of the first reactor.

Embodiment 16. A method for processing plastic material, the method comprising:
providing a feedstock to a first inlet positioned near a top portion of a cross-current reactor, the feedstock comprising plastic material;
providing oxidized oxygen carriers to a second inlet of the cross-current reactor, the oxidized oxygen carriers comprising active material and being provided such that a weight ratio of active material to feedstock is no less than 4:1 and no greater than 10:1;
providing one or more oxygen-source materials to a third inlet positioned near a bottom portion of the cross-current reactor, the one or more oxygen-source materials comprising steam (H₂O), carbon dioxide (CO₂), and/or oxygen (O₂);
obtaining syngas from a first outlet positioned near a middle portion of the cross-current reactor,
obtaining oxidized oxygen carriers from a second outlet positioned near the bottom portion of the cross-current reactor; and
recycling the oxidized oxygen carriers to the second inlet positioned near the top portion of the cross-current reactor.

Embodiment 17. The method according to Embodiment 16, the method further comprising:
recycling, using a riser, the oxidized oxygen carriers from the second outlet to the second inlet of the cross-current reactor.

Embodiment 18. The method according to Embodiment 16 or Embodiment 17, further comprising a second reactor in fluid communication with the cross-current reactor, and the method further comprising:
providing the oxidized oxygen carriers and/or partially oxidized oxygen carriers to a bottom inlet of the second reactor;
oxidizing the partially oxidized oxygen carriers in the second reactor; and
providing the oxidized oxygen carriers to the second inlet of the cross-current reactor,
   wherein the oxidized oxygen carriers are transported using a riser to the second inlet of the cross-current reactor.

Embodiment 19. A reactor system configured to process plastic material, the reactor system comprising:
a first reactor comprising metal oxide-based redox materials, the metal oxide-based redox materials comprising active material:
   a first inlet of the first reactor configured to receive a feedstock;
   a second inlet of the first reactor configured to receive oxidized metal oxide-based redox materials,
      wherein the active material and the feedstock have a weight ratio no less than 4:1 and no greater than 10:1 in the first reactor;
   a first outlet of the first reactor configured to provide oxidization products from the first reactor; and
   a second outlet of the first reactor configured to provide reduced metal oxide-based redox materials to the second reactor; and
the second reactor in fluid communication with the first reactor, the second reactor comprising:
   a first inlet of the second reactor configured to the receive reduced metal oxide-based redox materials from the first reactor;
   a second inlet of the second reactor configured to receive an oxidizing material;
   a first outlet of the second reactor configured to provide reduced products from the second reactor; and
   a second outlet of the second reactor configured to provide oxidized metal oxide-based redox materials.

Embodiment 20. The reactor system according to Embodiment 19, wherein the second reactor is a fluidized bed reactor or a moving bed reactor.

Embodiment 21. The reactor system according to Embodiment 19 or Embodiment 20, further comprising a riser in fluid communication between the first reactor and the second reactor, wherein the riser is configured to transport the oxidized metal oxide-based redox materials to the second inlet of the first reactor.

Embodiment 22. The reactor system according to any one of Embodiments 19-21, the system further comprising:
a pyrolysis reactor in fluid communication with the first reactor configured to provide char or heavy volatiles to the first inlet of the first reactor.

Embodiment 23. The reactor system according to any one of Embodiments 19-22, further comprising an oxidizer reactor in fluid communication with the first reactor and the second reactor, the oxidizer reactor configured to generate hydrogen gas (H₂):
a top inlet of the oxidizer reactor configured to receive reduced metal oxide-based redox materials from the second outlet of the first reactor;
a bottom inlet of the oxidizer reactor configured to receive steam (H₂O);
a top outlet of the oxidizer reactor configured to provide hydrogen gas (H₂); and
a bottom outlet of the oxidizer reactor configured to provide partially reduced metal oxide-based redox materials to the first inlet of the second reactor.

Embodiment 24. The reactor system according to Embodiment 23, further comprising a bypass stream configured to provide the reduced metal oxide-based redox materials from the first reactor to second reactor,
the bypass stream redirecting more than 0% and no greater than 90% of the reduced metal oxide-based redox materials from the first reactor to the second reactor.

Embodiment 25. The reactor system according to any one of Embodiments 19-24, wherein the first inlet of the first reactor is positioned at a top portion of the first reactor, and
the first outlet of the first reactor is positioned at a bottom portion of the first reactor.

Embodiment 26. The reactor system according to any one of Embodiments 19-25, wherein the first inlet of the first reactor is positioned at a bottom portion of the first reactor, and
the first outlet is positioned at a top portion of the first reactor.

Embodiment 27. The reactor system according to any one of Embodiments 19-26, wherein the first inlet of the first reactor is positioned at a middle portion of the first reactor,
the first outlet is positioned at the top portion of the first reactor, and
a third inlet is configured at the bottom portion of the first reactor, the third inlet configured to provide an enhancing agent comprising steam (H₂O) and/or carbon dioxide (CO₂) to the first reactor.

Embodiment 28. The reactor system according to any one of Embodiments 19-27, further comprising
a first non-mechanical device in fluid communication with the second outlet of the first reactor and the first inlet of the second reactor; and
a second non-mechanical device in fluid communication with the second outlet of the second reactor.

What is claimed is:

1. A method for processing plastic material, the method comprising:
providing a feedstock to a first inlet of a first reactor, the feedstock comprising plastic material;
providing oxidized oxygen carriers to a second inlet of the first reactor, the oxidized oxygen carriers comprising active material and being provided such that a weight ratio of active material to feedstock is no less than 4:1 and no greater than 10:1;
obtaining oxidation products from a first outlet of the first reactor;
providing reduced oxygen carriers from a second outlet of the first reactor to a first inlet of the second reactor;
providing an oxidizing material to a second inlet of the second reactor; and
obtaining energy and/or a second reactor product stream from the second reactor.

2. The method according to claim 1, the method further comprising:
transporting, using a riser, the oxidized oxygen carriers to the second inlet of the first reactor from a first outlet of the second reactor.

3. The method according to claim 1, further comprising providing the feedstock to an inlet of a pyrolysis reactor in fluid communication with the first inlet of the first reactor;
generating char or heavy volatiles using the pyrolysis reactor; and
providing the char or heavy volatiles from an outlet of the pyrolysis reactor to the first inlet of the first reactor.

4. The method according to claim 1, wherein the oxidized oxygen carriers comprise 50% by weight active material; and
wherein the weight ratio of active material to the feedstock is no less than 5:1 and no greater than 9:1.

5. The method according to claim 1, the feedstock and the oxidized oxygen carriers being provided to the first reactor as co-current streams.

6. The method according to claim 1, further comprising an oxidizer reactor in fluid communication with the first reactor and the second reactor;
providing the reduced oxygen carriers to a first inlet of the oxidizer reactor from the second outlet of the first reactor;
providing steam (H₂O) to a second inlet of the oxidizer reactor;
generating hydrogen gas (H₂) in the oxidizer reactor; and
providing partially reduced oxygen carriers to the first inlet of the second reactor.

7. The method according to claim 6, further comprising a bypass stream, the bypass stream directing at least 10% of the reduced oxygen carriers from the first reactor to the second reactor.

8. The method according to claim 1, the first reactor operating at a temperature between 300° C. to 1500° C.; and
the first reactor operating at a pressure between 0.1 MPa to 15 MPa.

9. The method according to claim 1, the second reactor operating at a temperature between 300° C. to 1500° C.; and
the second reactor operating at a pressure between 0.1 MPa to 15 MPa.

10. The method according to claim 1, the feedstock further comprising char or heavy volatiles.

11. The method according to claim 1, the oxidizing material comprising carbon dioxide (CO₂), steam (H₂O), air, oxygen (O₂), or combinations thereof; and
the second reactor product stream comprising carbon monoxide (CO), hydrogen gas (H₂) and/or syngas.

12. The method according to claim 1, further comprising:
removing, using a third reactor, at least one of chlorine (Cl⁻) ions, bromine (Br⁻) ions, or fluorine (F⁻) ions from the feedstock, thereby generating a dehalogenated stream, the first reactor being in fluid communication with the third reactor; and
providing the dehalogenated stream to the first inlet of the first reactor.

13. The method according to claim 1, wherein the second reactor product stream has a maximum tar content of no greater than 50 g/Nm³.

14. The method according to claim 1, the method further comprising:
providing one or more oxygen-source materials to a third inlet of the first reactor,
the one or more oxygen source materials comprising steam (H₂O) and/or carbon dioxide (CO₂).

15. The method according to claim 1, the method further comprising:
collecting an output stream comprising the oxidized oxygen carriers from a third outlet of the second reactor; and
providing the collected oxidized oxygen carriers to the second inlet of the first reactor.

16. A method for processing plastic material, the method comprising:
providing a feedstock to a first inlet positioned near a top portion of a cross-current reactor, the feedstock comprising plastic material;
providing oxidized oxygen carriers to a second inlet of the cross-current reactor, the oxidized oxygen carriers comprising active material and being provided such that a weight ratio of active material to feedstock is no less than 4:1 and no greater than 10:1;
providing one or more oxygen-source materials to a third inlet positioned near a bottom portion of the cross-current reactor, the one or more oxygen-source materials comprising steam (H₂O), carbon dioxide (CO₂), and/or oxygen (O₂);
obtaining syngas from a first outlet positioned near a middle portion of the cross-current reactor,
obtaining oxidized oxygen carriers from a second outlet positioned near the bottom portion of the cross-current reactor; and
recycling the oxidized oxygen carriers to the second inlet positioned near the top portion of the cross-current reactor.

17. The method according to claim 16, the method further comprising:
recycling, using a riser, the oxidized oxygen carriers from the second outlet to the second inlet of the cross-current reactor.

18. The method according to claim 16, further comprising a second reactor in fluid communication with the cross-current reactor, and the method further comprising:
providing the oxidized oxygen carriers and/or partially oxidized oxygen carriers to a bottom inlet of the second reactor;
oxidizing the partially oxidized oxygen carriers in the second reactor; and
providing the oxidized oxygen carriers to the second inlet of the cross-current reactor,
wherein the oxidized oxygen carriers are transported using a riser to the second inlet of the cross-current reactor.

19. A reactor system configured to process plastic material, the reactor system comprising:
a first reactor comprising metal oxide-based redox materials, the metal oxide-based redox materials comprising active material:
a first inlet of the first reactor configured to receive a feedstock;
a second inlet of the first reactor configured to receive oxidized metal oxide-based redox materials,
wherein the active material and the feedstock have a weight ratio no less than 4:1 and no greater than 10:1 in the first reactor;
a first outlet of the first reactor configured to provide oxidization products from the first reactor; and
a second outlet of the first reactor configured to provide reduced metal oxide-based redox materials to the second reactor; and
the second reactor in fluid communication with the first reactor, the second reactor comprising:
a first inlet of the second reactor configured to the receive reduced metal oxide-based redox materials from the first reactor;
a second inlet of the second reactor configured to receive an oxidizing material;
a first outlet of the second reactor configured to provide reduced products from the second reactor; and
a second outlet of the second reactor configured to provide oxidized metal oxide-based redox materials.

20. The reactor system according to claim 19, wherein the second reactor is a fluidized bed reactor or a moving bed reactor.

21. The reactor system according to claim 19, further comprising a riser in fluid communication between the first reactor and the second reactor, wherein the riser is configured to transport the oxidized metal oxide-based redox materials to the second inlet of the first reactor.

22. The reactor system according to claim 19, the system further comprising:
a pyrolysis reactor in fluid communication with the first reactor configured to provide char or heavy volatiles to the first inlet of the first reactor.

23. The reactor system according to claim 19, further comprising an oxidizer reactor in fluid communication with the first reactor and the second reactor, the oxidizer reactor configured to generate hydrogen gas (H₂):
a top inlet of the oxidizer reactor configured to receive reduced metal oxide-based redox materials from the second outlet of the first reactor;
a bottom inlet of the oxidizer reactor configured to receive steam (H₂O);
a top outlet of the oxidizer reactor configured to provide hydrogen gas (H₂); and
a bottom outlet of the oxidizer reactor configured to provide partially reduced metal oxide-based redox materials to the first inlet of the second reactor.

24. The reactor system according to claim 23, further comprising a bypass stream configured to provide the reduced metal oxide-based redox materials from the first reactor to second reactor,
the bypass stream redirecting more than 0% and no greater than 90% of the reduced metal oxide-based redox materials from the first reactor to the second reactor.

25. The reactor system according to claim 19, wherein the first inlet of the first reactor is positioned at a top portion of the first reactor, and
the first outlet of the first reactor is positioned at a bottom portion of the first reactor.

26. The reactor system according to claim 19, wherein the first inlet of the first reactor is positioned at a bottom portion of the first reactor, and
the first outlet is positioned at a top portion of the first reactor.

27. The reactor system according to claim 19, wherein the first inlet of the first reactor is positioned at a middle portion of the first reactor,
the first outlet is positioned at the top portion of the first reactor, and
a third inlet is configured at the bottom portion of the first reactor, the third inlet configured to provide an enhancing agent comprising steam (H₂O) and/or carbon dioxide (CO₂) to the first reactor.

28. The reactor system according to claim 19, further comprising
a first non-mechanical device in fluid communication with the second outlet of the first reactor and the first inlet of the second reactor; and
a second non-mechanical device in fluid communication with the second outlet of the second reactor.
